(19) United States
(12) Patent Application Publication
(10) Pub. No.: US 2017/0326688 A1
(43) Pub. Date: Nov. 16, 2017

(54) LASER-BASED MODIFICATION OF TRANSPARENT MATERIALS

(71) Applicant: IMRA America, Inc., Ann Arbor, MI (US)

(72) Inventors: Mark Turner, Milpitas, CA (US); Alan Y. Arai, Fremont, CA (US); Michiharu Ota, Newark, CA (US)

(21) Appl. No.: 15/658,944

(22) Filed: Jul. 25, 2017

Related U.S. Application Data
(63) Continuation of application No. PCT/US2015/068066, filed on Dec. 30, 2015.
(60) Provisional application No. 62/109,485, filed on Jan. 29, 2015.

(51) Int. Cl. B23K 26/382; B23K 26/142; B23K 26/402; B23K 26/0622; B23K 26/146; B23K 26/082; B23K 26/067; B23K 103/00

(52) U.S. Cl. CPC B23K 26/382; B23K 26/082; B23K 26/142; B23K 26/402; B23K 26/0676; B23K 26/0624; B23K 26/146; B23K 2203/52; B23K 2203/54; B23K 2203/50

(57) ABSTRACT

The present disclosure provides examples of a laser-based material processing system for liquid-assisted, ultrashort pulse (USP) laser micromachining An example material processing application includes drilling thru-holes or blind holes in a nearly transparent glass workpiece (substrate) using parallel processing with an n×m array of focused laser beams. Methods and systems are disclosed herein which provide for formation of high aspect ratio holes with low taper in fine pitch arrangements.

### CROSS-REFERENCE TO RELATED APPLICATIONS

This application is a continuation of international application no. PCT/US2015/068066, filed Dec. 30, 2015, entitled “Laser-Based Modification of Transparent Materials,” which claims the benefit of priority to U.S. Provisional Patent Application No. 62/109,485, filed Jan. 29, 2015, entitled “Laser-Based Modification of Transparent Materials,” each of which is hereby incorporated by reference herein in its entirety.

### FIELD

This disclosure relates to laser-based modification of transparent materials, and more particularly to water-assisted ultrashort pulse laser processing to form high aspect ratio, low taper holes at high speeds.

### BACKGROUND

Challenges exist for high-speed and high-quality processing of transparent materials, for example: drilling of fine pitch, closely spaced holes, formation of kerfs and trenches, laser cutting, and other micromachining applications which include controlled modification of target material on a microscopic scale.

### SUMMARY

Various systems and methods are disclosed for laser-based processing of transparent materials (and/or non-transparent and/or partially transparent materials). As used herein, processing is used in its ordinary and general sense and includes, but is not limited to, drilling, cutting, scribing, dicing, grooving, milling, machining, surface texturing, trepanning, and/or singulating. Processing a material can include (but is not limited to) micromachining the material, forming kerfs or trenches in or on the material, physically modifying the material (e.g., altering the refractive index and/or modifying a surface of the material), removing matter from the material, internally welding one or more materials, and so forth.

Embodiments of the systems and methods can be used for processing materials such as transparent substrates, glasses, multilayer transparent materials, and so forth. Such materials include, but are not limited to: display glass (e.g., glass with a chemically-strengthened, compression surface layer), sapphire, fused silica, quartz crown glass, tempered glass, non-tempered glass, soda lime glass, non-alkali glass, silicon carbide (SiC), silicon, diamond, transparent ceramics, aluminum oxynitride, etc. The systems and methods are not limited to processing transparent materials. In various embodiments, the systems and methods can be used for processing transparent, partially transparent, translucent, semi-opaque, opaque, and/or non-transparent materials.

Because transparency of a workpiece depends on wavelength, the transparency generally referred to herein is measured at the wavelength of the laser light that is used to process the workpiece. In many cases, the materials are transparent at wavelengths in at least a portion of the visible spectrum (e.g., at wavelengths in a range from about 400 nm to about 700 nm) and/or at one or more near-infrared laser processing wavelengths in a range from about 700 nm to about 2.5 μm. Transparent materials can include materials that have a percentage transmission of light (at the laser processing wavelength) through the material that is greater than about 75%, greater than about 80%, greater than about 85%, greater than about 90%, greater than about 95%, greater than about 99%, or even higher. Transparent materials can have an attenuation (at the laser processing wavelength) that is less than about 1.5 dB, less than about 1.0 dB, less than about 0.5 dB, less than about 0.25 dB, less than about 0.1 dB, or lower. Transparent materials can have an attenuation coefficient (in dB/km, at the laser processing wavelength) that is less than about 100, less than about 10, less than about 1, less than about 0.1, or lower.

In one example aspect, laser material processing is carried out at rapid speeds via parallel processing, for example with a spatial light modulator (SLM), diffractive optical element (DOE), or other multiple beam generator(s) capable of producing an array of beams. In at least one arrangement an ultrashort pulse laser output is steered along a pre-determined path to define a path for machining The multiple beam generator transforms a steered beam into an array of beams (e.g., beamlets) having a pre-determined angular distribution at an output of the multiple beam generator. The beamlets are provided as an input to a scanning and delivery system. By way of example, in at least one implementation an n×m array of beamlets is provided, with n, m having value(s) in the range from about 1 to about 5, or about 1 to about 10 (or even higher). In various implementations, n and m may be equal to each other, or not equal to each other. In some arrangements at least 100 holes per second may be formed, and up to about 500-1000 holes formed per second.

In another example aspect, the present disclosure features a laser-based method and system of water-assisted drilling of transparent materials to form high aspect ratio holes (e.g.: large depth to width ratio) having little taper, and to do so at processing speeds to support, for example, formation of at least about 10 holes per second, 25 holes per second, 50 holes per second, 100 holes per second, 1000 holes per second or more. In various implementations, high aspect ratio holes have a ratio of depth to width (e.g., diameter for circular holes) that is greater than 2, greater than 3, greater than 5, greater than 10, greater than 20, greater than 50, greater than 100, greater than 200, greater than 500, greater than 1000, or more. High aspect ratio holes can have a ratio of depth to width (e.g., diameter for circular holes) that is in a range from about 2 to 1000, from about 2 to 200, from about 3 to 30, from about 5 to 20, from about 10 to 100, or some other range. Holes with little taper can have a change in diameter (over the length of the hole) that is less than about 10%, less than about 5%, less than about 1%, or smaller. Holes with little taper can have a ratio of exit diameter to entrance diameter that is approximately equal to one, e.g., the ratio is within 10%, 5%, 1% of 1.0. In another example aspect, the present disclosure features a laser-based method and system of drilling in which debris resulting from laser ablation is reduced with circulation of degassed water, for example, in contact one or more surfaces of the material being processed. A beneficial effect is the enhanced capability of drilling high aspect ratio holes with little taper while limiting formation of recast material within or near a hole (e.g.: the hole wall or local substrate region) and heat dissipation from cumulative pulse effects. As an example, a dissolved oxygen level in the degassed water may be less than approximately 4.2 mg/liter, less than about 2 mg/liter, and preferably less than about 1 mg/liter. As a reference, the dissolved oxygen level in water at room temperature is around 8.4 mg/liter when measured with the same sensor.

In another example aspect, the present disclosure features a laser-based method and system of drilling where the focused laser beam interacts with the water below or within the hole to produce optical breakdown and cavitation which then acts to produce a pressure pulse of sufficient magnitude to eject the debris produced by the laser ablation of the material out of the hole or kerf.

In another example aspect, the present disclosure features a laser-based method and system as above which includes an ultrashort pulse laser system configured to operate at a high available repetition rate and to exploit a previously unforeseen correlation between hole geometry and repetition rate. For example, it was determined that the following approximate relationship holds in some implementations: Rₒₚₜ≈(k·D)/L(t), where k is in the range from about 250 to 350 kHz, L(t) is the hole depth as a function of time, t (e.g.: length of hole), D is the hole diameter (a constant, for non-tapered holes), and Rₒₚₜ is a preferred or optimum repetition rate, measured in kHz, for rapid drilling while avoiding buildup of debris. Rₒₚₜ is effectively an optimum repetition rate for drilling thru-holes or blind holes of length L. Rₒₚₜ need not be constant and can vary with the depth of the hole as the drilling process progresses (e.g., as L(t) changes with time). The optimum repetition rate Rₒₚₜ may be capped at a maximum value (e.g., when L(t) is much smaller than D), where the maximum value is in a range from about 100 kHz to about 1 MHz.

In another example aspect, the hole drilling may be carried out utilizing a drilling (or more generally, processing) path in which at least some consecutively drilled holes are separated by more than a nearest neighbor distance. For example, it is beneficial to separate consecutive drilling sites such that distance exceeds that over which bubble(s) produced by the process can travel. Nearby holes can be drilled later after the bubbles that have attached to the nearby surface dissolve or are otherwise removed. Moreover, it can be advantageous to drill holes such that bubbles dislocated by water flow will be pushed toward region(s) where drilling has been completed or where no holes will be drilled.

In another example aspect, the hole drilling may be carried out with a gas jet positioned such that it directs any water that leaks through a previously drilled hole, away from the active drilling region and toward a region on the target material where holes have already been drilled or where no holes will be drilled.

In another example aspect, the circulating water is continuously filtered to remove debris produced by the laser drilling process and remove dissolved gases in the water so that gases produced by the laser ablation process can be quickly dissolved into the water rather than creating long-lived bubbles.

In another example aspect, the circulating water is heated to assist with removal of dissolved gases.

In another example aspect where the water is in contact below the target material, the focus position of the laser beam starts below the target material and within the water. The focus position of the laser beam is then translated upward through the target material while drilling a hole. Thru-holes, blind holes, grooves, trenches, kerfs, or other features can be drilled. The target material may be cleaned (e.g., in a liquid bath or via ultrasonic techniques) to remove debris formed during the laser processing.

In another example aspect, exit chipping of thru-holes is reduced by applying to the workpiece, prior to laser processing, a thin film coating, thick film coating, or adhesive. The coating(s) or adhesives can be removed subsequent to laser processing. Additionally or alternatively, a thickness of support glass may be bonded or otherwise attached to the workpiece prior to laser processing, with or without a layer of adhesive. In some implementations a carrier wafer may be utilized as support glass. The support glass is de-bonded or otherwise removed subsequent to laser processing.

In another example aspect, a liquid assisted laser processing system according to the present disclosure may be programmed to drill thru holes or blind holes in a transparent workpiece (e.g.: glass). The holes may have relatively little taper and may have a nearly constant diameter over the hole length (e.g., variation in diameter less than about 5% to 10%). Holes with a pre-selected taper can be formed, for example, by controlling a trepanning radius of the laser beam. However, the system may be programmed to form other pre-selected shapes in the surface and/or bulk of the workpiece material, for example blind holes or grooves with a specified maximum and minimum diameter and/or taper. In some implementations geometric shapes of the holes or features need not be circular and may be, for example, elliptical, oval, square, rectangular, or polygonal in one or more dimensions.

In another example aspect, methods for transforming a blind hole into a thru-hole are provided. The methods may be applied after the laser processing of the blind hole is completed and may include one or more of laser polishing, laser etching, or chemical etching the workpiece to remove a membrane of material between a closed end of the blind hole and a surface of the workpiece.

In another example aspect, a laser-based system is provided for carrying out at least any or all of the above methods.

Details of one or more implementations of the subject matter described in this specification are set forth in the accompanying drawings and the description below. Other features, aspects, and advantages will become apparent from the description, the drawings, and the claims. Neither this summary nor the following detailed description purports to define or limit the scope of the inventive subject matter.

### BRIEF DESCRIPTION OF THE DRAWINGS

FIG. 1 schematically illustrates an arrangement of a laser-based material processing system for water-assisted, ultrashort pulse laser micromachining, for example for drilling thru-holes or blind holes in a glass.

FIG. 2 is a block diagram schematically illustrating a particular example of a laser processing system according FIG. 1, including a laser and optical system arrangement.

FIGS. 2A and 2B schematically illustrate a portion of a laser and optical system arrangement of FIG. 2.

FIGS. 3A and 3B respectively illustrate an example of a water circulation system and an example of a workpiece fixture for use in the water-assisted laser processing system.

FIG. 3C schematically illustrates an example of a portion of a water-assisted drilling system in which a gas jet is arranged to direct unwanted liquid away from active/local laser processing locations, more particularly toward previously drilled holes, a region on the where hole drilling is complete, or where no holes will be drilled.

FIG. 4A illustrates top and bottom views of a 10-μm diameter hole formed in 100-μm thick glass, demonstrating the capability of forming micron-sized holes with low taper and negligible chipping.

FIG. 4B illustrates 20-μm diameter holes formed with 25-μm pitch through 100-μm thick glass, including an expanded view showing two fabricated holes.

FIG. 4C illustrates various considerations for drilling fine pitch holes.

FIG. 5A illustrates 30-μm diameter holes through 100-μm thick glass produced with use of a 2×4 array of beams produced by SLM for parallel processing.

FIG. 5B illustrates beam profiles of the 2×4 array produced with the SLM, obtained in the transform plane of the spatial light modulator (SLM).

FIGS. 6A and 6B are plots illustrating a measured response time of a commercial SLM and the overall frequency response, respectively.

FIG. 7 is a plot illustrating an example of variation of repetition rate with hole depth according to an empirical relation.

FIGS. 8A-8D schematically illustrate an example of the water-assisted laser drilling of a thru-hole in a workpiece and formation of an exit chip.

FIGS. 9A-9D schematically illustrate example techniques for reducing exit chipping of thru-holes.

FIG. 10 is a flowchart that illustrates an example method for processing a workpiece.

Unless the context indicates otherwise, like reference numerals refer to like elements in the drawings. The drawings are provided to illustrate embodiments of the disclosure described herein and not to limit the scope thereof.

### DETAILED DESCRIPTION

### Overview—High-Speed, Water-Assisted Drilling System

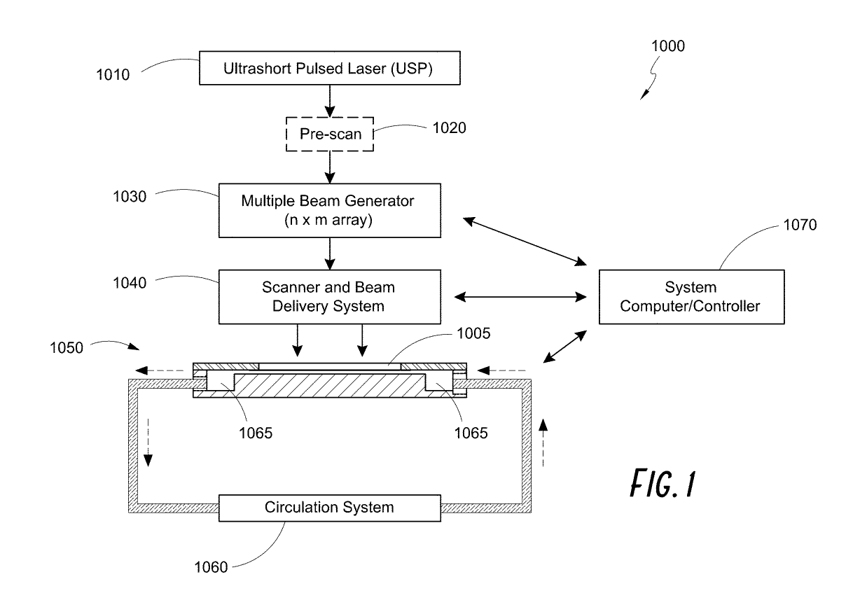

FIG. 1 schematically illustrates an arrangement of a laser-based material processing system 1000 for water-assisted, ultrashort pulse (USP) laser micromachining By way of example, a material processing application of interest includes drilling thru-holes or blind holes in a nearly transparent glass workpiece (e.g., substrate, sample, or wafer) using parallel processing with an n×m array of focused beams.

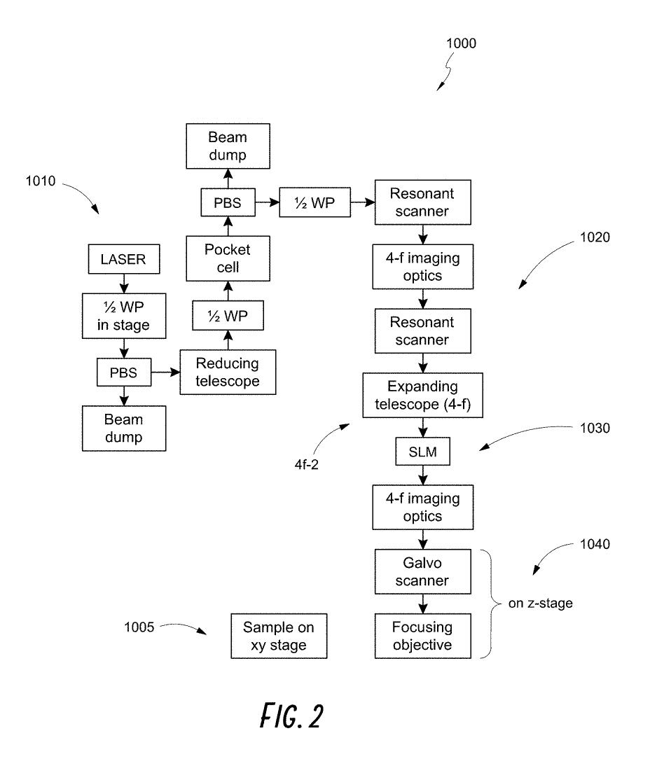

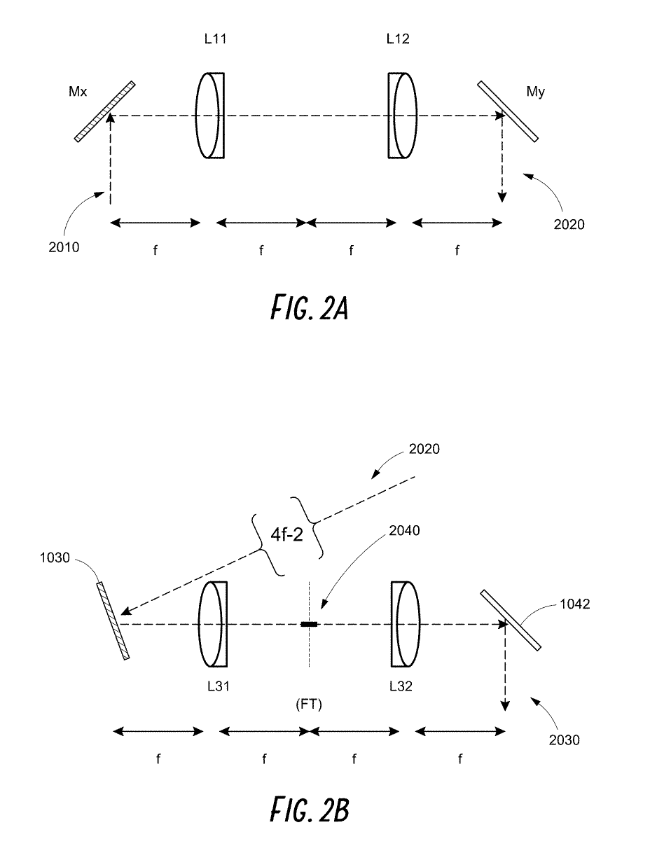

The example system 1000 illustrated in FIG. 1 includes an ultrashort pulse laser source 1010 and associated optical system (see, e.g., FIG. 2). An optional pre-scanning arrangement 1020 is arranged to generate a scanning beam having a predetermined path for drilling a single hole, and is particularly advantageous for rapid scanning over the pre-determined path. For example, pre-scanner 1020 may be configured to receive pulsed laser input beams from the USP 1010 and to steer beams along a pre-determined path, for example the locus of the beams forming a circle, spiral, concentric circles, rectangle, polygon or other geometric shape(s) for particular processing applications. Trepanning and/or wobbling may be used, both which are well known from conventional laser drilling systems and literature.

In the system of FIG. 1 a multiple beam generator 1030 receives a beam from the pre-scanner 1020 and generates a discrete set of beams, for example an n×m array of beams (e.g.: beamlets) as used in certain examples below. The beam(s) are focused and delivered to the workpiece. In some implementations the beamlets of the n×m array may be identical, but this is not required. A spatial distribution of beamlets for may form a regular array, irregular array, sparse array, and the array may be non-rectangular. Upon focusing and delivery of the beams to a workpiece 1005 with the scanner and beam delivery arrangement 1040, the scan path of each beamlet corresponds to the pre-determined path generated with the pre-scanner. Transparent material of the workpiece 1005 is modified within an instantaneous field of the scanner and beam delivery system 1040. Controller 1070 is operatively connected to the pre-scanner 1020 and to the scanner and beam delivery system 1040 for beam motion control and workpiece positioning, which may include simultaneous beam steering, sequential beam steering, or workpiece positioning in accordance with processing applications. Thru-holes or blind holes in a relatively thick workpiece may be formed by shifting the focal plane with z-axis translation of the workpiece and/or focusing lens (not shown in FIG. 1).

Generation of the array with the multibeam generator can reduce some requirements for high speed scanning For example, in some implementations, and if processing speed is sufficient, the scanning mechanism utilized in the scanner and beam delivery system 1040 may steer the n×m array of beamlets produced by the SLM in a predetermined path for drilling. The scanning mechanism of 1040 may also shift the position of the scan field (e.g., in X, Y, X-Y or X-Y-Z directions) or otherwise selectively direct the beams for processing the workpiece. In such an arrangement the optional pre-scanner may be absent (or not active). Accordingly, the SLM generates the n×m array with the USP output (and associated USP optical system). Any suitable combination of stages and scanning equipment may be utilized to position the workpiece or beams. Considering goals for high density, fine pitch, varying hole patterns, and processing speed operation with both pre-scanner 1020 and X-Y scanning mechanism of 1040 may be particularly advantageous.

In at least one arrangement the workpiece 1005, which may optionally be mounted on one or more motion stages (e.g.: translation and/or rotation stages, not shown in FIG. 1), is positioned and the drilling process continued with the same n×m array or with a modified beam or array via controller input to the multiple beam generator 1030.

If the multiple beam generator 1030 includes a spatial light modulator (SLM) considerable flexibility is provided for generating array patterns (beamlets) via programming of the SLM, more specifically with use of a computer generated hologram (CGH) which defines a pre-determined SLM pattern. Frequency response characterization of a commercially available SLM showed that 20-30 ms (e.g.: 1 standard video frame time) is sufficient for updating the SLM pattern, although some variations may be expected for different SLM designs. SLM updating may overlap with other system operations, for example substrate positioning, and thus have reduced or negligible effect on throughput.

SLM programming parameters will vary according to the hole patterns that are to be used for a particular workpiece. In some implementations throughput may be optimized with various combinations of parallel processing and single beam drilling. The SLM may be programmed accordingly and may be configured to produce a single output beam up to an n×m array, for example with n, m in the range from about 1 to about 5 or 10.

In some embodiments, relative motion of the transparent workpiece (e.g.: glass substrate, glass wafer, sample, or other material to be laser processed) and laser beam(s) may be carried out with translation of various elements of the laser system and with a stationary substrate. In some embodiments, various combinations of substrate motion and motion of elements of the laser system may be implemented.

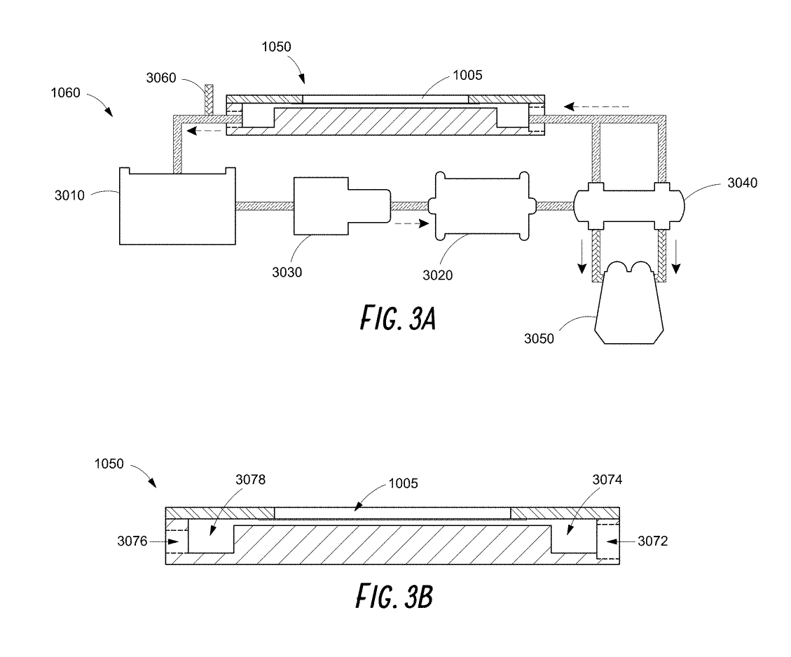

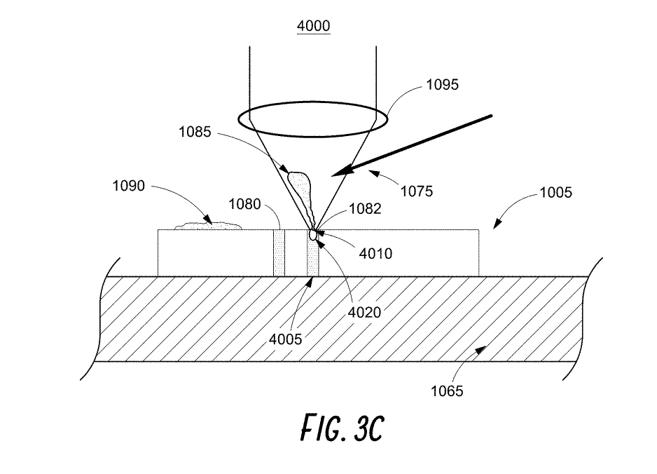

A workpiece fixture 1050 is arranged for liquid-assisted processing such that a portion of the workpiece 1005 is in contact with a liquid 1065 (e.g.: water or other suitable gas-soluble liquid). The material processing system further includes a liquid circulation system 1060. The circulation system can include a water pump, a water filter, a degas filter, and a water bath (which may be heated). The circulation system 1060 can also include an air vent and a vacuum line (see, e.g., the example in FIG. 3A). Dashed arrows in FIG. 1 show an example of the circulation of the liquid 1065 produced by the liquid circulation system 1060.

A system controller 1070 provides for monitoring and controlling sub-systems and components. System controller/computer 1070 may be in communication with each of the sub-systems which, in turn, may include distributed (local) programs for system operation and control, for example SLM pattern modification based on one or more CGHs, control of the circulation system, laser and scanning system calibration and the like.

In one experimental implementation, and with pre-scanning 1020 deactivated, the optical axis of the beam is steered onto the reflective SLM at a small angle of incidence of about 2.3° from normal. An ideal angle of incidence in some cases is zero degrees, but small angles of incidence (e.g., less than about 1°, less than about 2°, less than about 5°, less than about 10°) may be acceptable. The SLM was imaged to the exit aperture of an XY galvanometer scanner (available from SCANLAB AG, Puchheim, Germany) using a 4-f system, where each lens pair included 400-mm achromatic doublets. A focusing lens such as F-Theta lens, telecentric lens, or objective lens was placed at the exit of the galvanometer scanner. As an example of operation the pre-scanning resonant mirror amplitude, A, was increased from zero to A degrees via a commercially available scan controller. The angle of incident on the SLM varied from A°-2.3° to A°+2.3° in one dimension and +A° to −A° in the orthogonal direction.

The small incident angle to the SLM may be reduced or eliminated using an optical isolator so that the incident beam and reflected beam angles would then be perpendicular to the SLM surface, reducing or eliminating any asymmetry due to the small angle described above. A polarization beam splitter can be used to separate the incident and the reflected beams. The SLM can be mounted at a 45° angle relative to the typical mounting configuration in order to accommodate the beam rotation from the optical isolator.

The system 1000 can include other components such as, e.g., beam dumps, beam splitters, reducing telescopes, periscopes, shutters, Pockels cells, electro-optic modulators, half- or quarter-waveplates, etc.

### Example Systems for Parallel Laser-Based Material Processing

Referring to FIG. 1 the laser 1010 may include an ultrashort pulse (USP) source which provides ultrashort pulses having suitable pulse characteristics for modifying transparent material. By way of example, ultrashort pulse widths may be in the range from about 100 femtoseconds (fs) to about 500 picoseconds (ps). In various implementations fiber-laser-based systems may be utilized. For example, chirped pulse amplification systems provided by or under development at IMRA America, Inc. (Ann Arbor, Mich.) are capable of providing sub-picosecond ultrashort pulses with pulse energy up to about 50 μJ (e.g., FCPA μJewel series). Some implementations may utilize high-power, solid-state ultrashort pulse laser systems. Various USP sources that can be used with various embodiments of the systems and methods disclosed herein are disclosed in at least U.S. Patent Application Pub. No. 2010/0025387 ('5387), “Transparent material processing with an ultrashort pulse laser”, and/or U.S. Pat. No. 8,158,493 ('493), “Laser-based material processing methods and systems”, each of which is hereby incorporated by reference herein in its entirety.

By way of example an ultrashort pulse energy may be in the range from about 0.5 or 1 microJoule (μJ) up to about 20 μJ, 50 μJ, 100 μJ, 200 μJ or in certain embodiments up to about 1 milliJoule (mJ). In very high peak power/high intensity arrangements limits are imposed by optical damage and operation in a self-focusing regime, and are to be considered in the optical design. A pulse energy may be selected based on the fluence (e.g., Joules/cm²) and/or intensity (e.g., W/cm²) appropriate for modification of workpiece material. Ultrashort pulse characteristics may include a pulse width in the range from about 100 fs to 10 ps, 100 fs to 100 ps, 1 ps to 100 ps, or similar ranges. In at least one preferred implementation a pulse width in the range from about 100 fs to about 1 ps may be utilized. Intensity of a focused beam at the workpiece may be in the range from about 0.25×10¹² W/cm² up to about 10¹³ W/cm², and the fluence may be determined from the pulse width and intensity. The fluence may exceed a single-shot ablation threshold for the transparent material at an operating wavelength, or the single pulse fluence may be somewhat less than a single-shot threshold and characterized relative to a reduced multiple pulse threshold. In a preferred implementation a fiber-based chirped pulse amplification (FCPA) system may be utilized to generate ultrashort pulses with peak power in the range from about 1 MW to 20 MW, sub-picosecond pulses (e.g.: 100 fs-1 ps), and pulse energy of about 20 μJ. Available pulse repetition rate may be in the range from about 10 kHz, 50 kHz, 100 kHz, and up to about 5 MHz. In at least one preferred implementation for water-assisted drilling of glass substrates the repetition rate is selected or varied based on specified hole parameters, for example the depth of the hole to be drilled, and repetition rates may be in the range from about 10 kHz up to about 50 kHz, 70 kHz, or 100 kHz. Ultrashort pulses may be generated at near infrared (IR) wavelengths (e.g.: about 1 μm) or frequency converted (or generated) to produce visible (e.g., wavelengths from about 400 nm to 700 nm) or near ultraviolet (UV) outputs (e.g., wavelengths from about 300 nm to 400 nm). In some embodiments, USP may be generated or frequency shifted into the IR (e.g., from about 700 nm to 2.5 μm).

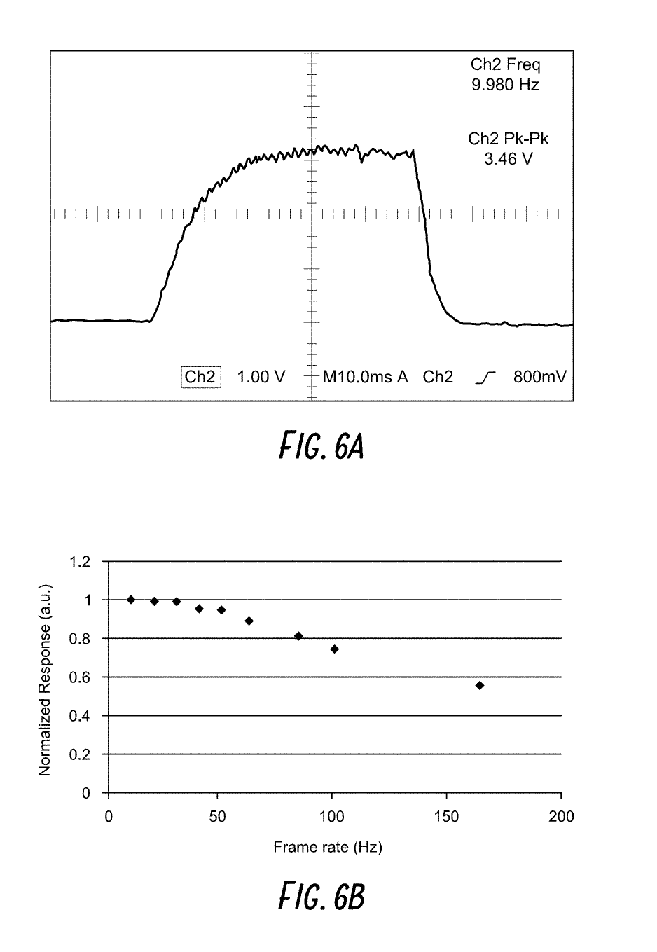

USP output pulse energy can be shared among multiple laser spots for parallel processing of the transparent material. Thus, relatively high energy USP is preferred. In some embodiments multiple lasers may be utilized with suitable beam combining optics to provide sufficient pulse energy. In some applications the pulse energy may be increased with the use of parallel arrays of pulse amplifiers the outputs of which are coherently combined, incoherently combined, or distributed to separate optical systems for parallel processing. By way of example methods and systems for increasing the pulse energy of fiber-based systems are disclosed in U.S. Pat. No. 8,199,398 ('398), “High power parallel fiber arrays” (e.g.: coherent combiner), U.S. Pat. No. 7,486,705 ('705), “Femtosecond laser processing system with process parameters, controls, and feedback”, (e.g.: FIG. 6 and associated text which illustrates a beam separator to divide a pulse into time separated portions followed by recombining of temporally separated pulses after amplification), and U.S. Patent Application Pub. No. 2012/0230353 ('353), “Optical pulse source with increased peak power” (e.g.: recombining time separated pulses, amplified pulses to form a pulse with increased peak power). The disclosures of '398, '705, and '353 are hereby incorporated by reference in their entirety.

USP optics may be provided with a commercially available unit (not shown), in an end user configuration for the material processing application, or both. USP optics may provide for beam expansion/reduction, polarization control, wavelength conversion/selection, modulation/intensity control, pulse selection, down counting, beam motion, or other operations.

In the example of FIG. 1 the optional pre-scanning arrangement 1020 defines a workpiece machining path for producing a single hole which is to be replicated for drilling multiple holes in parallel (substantially simultaneously). Laser drilling methods for generating holes may be classified in two categories: percussion drilling and trepanning as disclosed, for example, in Ready, John F. (ed.), “Hole drilling”, LIA Handbook of Laser Material Processing, Chapter 13, pgs. 471-474, Laser Institute of America, 2001. In many trepanning laser drilling applications, particularly on the scale of micromachining, the hole size to be drilled is much larger than a focused spot size. As such, a drilling beam is rotated and advanced through the material. In contrast, percussion drilling the laser beam is focused to a size approximately that of the hole to be drilled, and one or more pulses used to drill the hole. In various embodiments of the present disclosure trepanning is utilized to form holes having a diameter larger than a focused laser spot size. Also, a hole with a pre-selected taper can be formed, for example, by controlling the trepanning radius of the laser beam. The taper (between ends of the hole) can be a linear taper or any other type of taper.

In at least one embodiment of the present disclosure the pre-scanner 1020 generates a trepanning beam prior to being directed to the multiple beam generator 1030. In at least one arrangement the pre-scanner includes a pair of resonant scanners for trepanning Resonant scanners with compact mirrors are capable of relatively high speed operation when compared to higher inertia scanners, e.g.: X-Y linear galvanometers, rotating prisms, and the like. However, additionally or alternatively, such higher inertia scanners may be implemented if trepanning speed is sufficient. In certain implementations a two dimensional acousto-optic deflector may be utilized for high speed trepanning, provided that any lens effects associated with the scan rate and dispersive effects resulting from ultrashort pulses are sufficiently compensated.

The multiple beam generator 1030 may include, for example, a spatial light modulator (SLM) to form an array of n×m beams (e.g., beamlets). The device may be configured as a reflective liquid crystal-based SLM. One example of such an SLM is an HSPDM512—1064-PCIe, available from Meadowlark Optics (Frederick, Colo.; formerly Boulder Nonlinear Systems Inc. (BNS)) designed for wavelengths about 1064 nm. With parallel processing an approximate increase in drilling speed can be up to n×m times the speed achievable with a single beam, depending on the repetitiveness of the patterns to be drilled, density, and other factors associated with an application. In some implementations the array size achievable with a multiple beam generator may be n×m up to about 5×5, or 10×10, or higher. Values of n, m will depend at least partly on the size of the hole pattern to be machined and the diameter of the individual holes, and the field size may be any value in the range from 1 to about 10, for example: 3×3, 2×4, 1×8. As discussed above, SLM generated patterns are not restricted to rectangular arrays and some implementations may include circular array(s), hexagonal arrays, polygons, or other desired geometric shapes.

In some laser processing applications the multiple beam generator 1030 may alternatively or additionally include at least one diffractive optical element (DOE) to produce the beamlets. Additionally or alternatively bulk optical elements to distribute beams(s), for example a series of movable beam reflectors having transmissive and reflective portions as discussed in U.S. Pat. No. 5,948,291, entitled “Laser beam distributor and computer program for controlling the same”. The choice of device(s) for a particular application may depend on specific application goals. Many variations are possible.

The beamlets are received by the scanner and beam delivery system 1040 which delivers focused beamlets to the target material (e.g., workpiece 1005) using a pre-determined scan pattern. In at least one implementation conventional X-Y galvanometer-based mirrors may be used with a scan lens and a dynamic focusing mechanism to deliver the beamlets to the workpiece target material. A flat field or telecentric scan lens may be utilized.

### Example of a Laser and Optical Arrangement

FIG. 2 schematically illustrates an example of a particular laser and optical system arrangement for parallel material processing. The arrangement includes a USP source (1010), pre-scanner (1020), an SLM as a multiple beam generator (1030), and scanner/beam delivery system (1040). The arrangement further includes the workpiece 1005 (sample) and positioning mechanism (e.g.: X-Y stage).

The laser output, for example a series of ultrashort pulses, is directed to an external pulse picker (e.g., a Pockels cell). A beam reduction telescope and polarization components can be utilized to adjust the beam size and polarization for the Pockels cell. The pulse picker is used to vary the effective repetition rate of the laser, more particularly as a down counter to selectively adjust the rate at which laser pulses are provided to the downstream optical components and target material. The Pockels cell may be used as a high speed intensity modulator and/or for laser power control in the laser processing system, over a dynamic range of at least about 50:1. A combination of a half-waveplate (½ WP or HWP) and polarizing beamsplitter cube (PBS) attenuates the laser to the desired power.

In the example of FIG. 2 an electro-optic modulator (e.g., a Pockels cell) is used for intensity modulation and/or pulse selection. Polarization optics (e.g.: waveplates) in combination with beam expansion/reduction optics are used to inject and extract laser pulses. In some embodiments acousto-optic (AO) cells may be used with appropriate beam shaping optics. The pre-scanner may include a resonant scanning mirror(s) for scanning in one or both directions, which can provide for somewhat higher trepanning rates than linear galvanometer-based systems. Alternatively or additionally linear galvanometer mirrors may be programmed to generate a trepanning laser spot at sufficiently high speed for various drilling or micromachining applications.

In the arrangement of FIG. 2 the pre-scanner 1020 includes X-Y mirrors (e.g.: resonant scanners) for beam steering and multiple 4-f optical sub-systems with suitable beam manipulation optics for beam size and shape control. The scanning beam, which may be further expanded and/or reduced to match the useful SLM clear aperture, propagates downstream to a multibeam generator which includes an SLM in this example. The multiple beam generator 1030 forms the n×m array of beamlets. Each beamlet is then focused and delivered to the workpiece 1005 for parallel machining with the predetermined trepanning path produced with the pre-scanner 1020.

FIG. 2A illustrates part of an example pre-scanning arrangement in further detail. In this example, a 4-f imaging system is disposed between the mirrors Mx and My, where the two mirrors rotate about perpendicular directions x and y, and includes two lenses, L11 and L12. In this example both lenses L11 and L12 have the same focal length, f, but can be of different focal length to create magnification. The arrangement with a 4-f imaging system disposed between Mx and My provides flexibility for operation, particularly in a workstation environment. In various implementations the optical path lengths may be reduced and this first 4-f system eliminated by disposing the mirrors Mx and My in close proximity In some implementations beam path compensation techniques may be implemented to effectively cancel the mirror offsets in a relatively compact arrangement.

In the present example, the lenses L11 and L12 are disposed at a distance of 2 f from each other as shown. First scan mirror, Mx, is located a distance f from L11 (e.g.: lens center or principal plane), in an object plane of the lens. Second scan mirror, My, is located a distance f from the lens L12 (e.g.: lens center or principal plane), in an image plane. The arrangement results in the mirror Mx being imaged to the mirror My. This arrangement effectively maintains the beam on the mirror My stationary when the mirror Mx moves. The USP laser beam 2010 is incident on the first scan mirror, Mx. The beam exits the second scan mirror, My, resulting in an X-Y pre-scanned beam 2020. The pre-scanned beam 2020 can be directed to an additional 4-f system.

In at least one preferred implementation an additional 4-f system imaging system, shown in FIG. 2 and illustrated symbolically as 4f-2 in FIG. 2B, images the pre-scanned beam 2020 to the multiple beam generator 1030 (e.g., an SLM), such that the incident beam at the face of the SLM is stationary. The 4f-2 arrangement may also be arranged to magnify the beam to an appropriate size for the SLM useful aperture.

Referring to FIG. 2B, a similar optical arrangement to that in FIG. 2A provides for imaging of the SLM (or other multiple beam generator), and beamlets generated therewith, into a downstream X-Y scanning system for delivery to the workpiece. First, the beam received from a second 4-f imaging system of FIG. 2B, (4f-2), is incident on the SLM. An additional 4-f imaging system shown in FIG. 2B includes two lenses, L31 and L32 for imaging the SLM onto the exit pupil of a scanning system 1042. In this example both lenses have the same focal length, f, but can in general be of different focal length to create magnification. The lenses are disposed a distance of 2 f from each other. The object plane (the SLM) is located a distance f from lens L31 (e.g.: lens center or principal plane). The image plane, which corresponds to the exit aperture of the X-Y scanner 1042 is located a distance f from the center (e.g.: lens center or principal plane) of the lens L32. This results in the SLM, and the emerging n×m array of beamlets, being imaged to the exit aperture of the X-Y scanner system 1042, and a beam 2030 can be directed to where a nearby focusing objective is placed. The focusing objective delivers the focused beams to the workpiece 1005, all illustrated in FIG. 2. Notably, a Fourier transform (FT) of the SLM pattern is conveniently formed in a transform plane FT, in the back focal plane of L31.

By way of example the multiple beam generator 1030 can be a commercially available liquid crystal-based spatial light modulator (SLM-LCD), preferably provided with a calibration curve. Wavefront correction may be applied to reduce unwanted spatial phase variations. With certain polarization sensitive SLMs a λ/2 waveplate may be used to rotate the polarization incident on the SLM so that the polarization is parallel to the vertical axis of the SLM.

### Some Further System Considerations

Additional considerations arise related to long term stability and beam management for laser processing systems, which may be utilized in all-day (e.g., 24/7) operation. In some implementations, and to compensate for manufacturing variations and time-dependent focal length variations in the system, additional optical elements may be included to provide correction of the focal length and magnification. In a preferred implementation automatic calibration routines are implemented and optical adjustments provided via the controller.

In some laser processing applications high numerical aperture (NA) optical systems may be utilized to produce small features, accompanied by reduced depth of focus. Three dimensional alignment and positioning mechanisms may be used to minimize depthwise variation over the workpiece. Conventional dynamic focusing and surface following methods employed for semiconductor measurement and processing, may be utilized to compensate for the reduced depth of focus. Preferably, deviation of workpiece surface flatness and orthogonality will be sufficiently small to reduce or avoid dynamic adjustment within the field of the n×m array of beamlets. As will be further discussed below, in at least one implementation z-axis adjustment over a range which exceeds the total thickness of the workpiece and the depthwise variations associated with fixture (e.g.: tolerance stackup) can reduce or avoid a requirement for z-axis adjustment within a field.

Additionally, in various implementations the zeroth order beam reflected from the SLM, unless being utilized, should be blocked so that any residual zero order power has no effect on laser processing results. The zeroth order beam from the SLM should be blocked without generating forward propagating stray light and without affecting any of the diffracted spots (beamlets) generated by the SLM. In at least one implementation the pattern of diffracted spots is slightly shifted, for example by about 5-10 μm, to allow for blocking of the zeroth order. As an example, a compact three-dimensional positioning mechanism may be used to position a wire 2040 in the Fourier plane (FT) to block the zeroth order as illustrated in FIG. 2B.

In at least one implementation the zeroth order block is to be adjusted so that different SLM generated patterns may be utilized. One advantage of using an SLM is the ability to generate various patterns via computer generated holograms (CGH). In some implementations, such as an array where n and m are odd integers (e.g., a 3×3 array), the zero-order beam can be used as the central beam of the pattern. In such an arrangement the intensity of the zero-order beam can be controlled via the CGH to avoid over-exposure of the hole that includes the high intensity zeroth order beam.

### Example High Speed Water-Assisted Drilling

One aspect the present disclosure is a water-assisted system for wafer-sized samples (e.g.: about 6 inch or about 15 cm diameter) and continuous processing. Referring again to FIG. 1, sub-system(s) for water flow control, debris filtration, degas, and heating can be included. A continuous-flow water-assisted system may reduce exit surface chipping relative to prior systems and provide for bubble removal and control. Water-assisted drilling has several possible benefits: (i) remove debris from high aspect ratio holes through cavitation-force expulsion, (ii) cooling of debris particles to prevent recast inside the holes, (iii) cooling of the substrate to prevent cracking, and/or (iv) debris capture (not in the air). Water-assisted machining of transparent materials can produce very small holes with high aspect ratios, and negligible taper, as will be illustrated in examples that follow.

Considerations and challenges include processing constraints caused by bubble accumulation blocking water from entering holes. Without water, there is no cavitation pressure to help eject the debris, particularly for relatively deep holes with a high aspect ratio. If the debris cannot be ejected from the hole, the drilling slows and eventually stops. Furthermore, after a hole is drilled water can pass through the hole to the exit surface and interfere with the laser focusing for subsequent nearby holes. A tradeoff exists between exit surface chipping and processing speed. The exit surface chipping is believed to be due to the cavitation in the water from optical breakdown when the hole is very close to the exit surface. This pressure breaks through the thin remaining layer of glass, producing the exit surface chipping. Higher pulse energy together with faster z-axis translation will reduce the time to drill a hole, but generally produces more chipping at the exit surface compared to lower pulse energy with slower translation speed. Some optimization is possible by using a low pulse energy and translation speed near the exit surface, and higher pulse energy with higher translation speed within the bulk of the substrate where the material is thick enough to withstand the cavitation pressure. Such considerations can arise in both conventional single beam drilling systems and systems in which parallel processing is implemented. Additional techniques and arrangements for reducing exit chipping are discussed in examples below.

Referring to FIG. 1, and as discussed above, a workpiece fixture 1050 is arranged such that a portion of the workpiece 1005 (e.g.: substrate) is in contact with liquid 1065 (e.g.: water). The system 1000 further includes a liquid circulation system 1060. The circulation system can include a water pump, a water filter, a degas filter, and a heated water bath.

In at least one implementation, the water is below the substrate and in direct contact with the substrate. By way of example, the laser is directed from the top. Processing commences with initial focus below the substrate in the water and the focus is slowly translated upwards using, for example, a Z-stage (as illustrated in FIG. 2). The z-direction range of the beam focus translation starts below the substrate with some margin and ends above the substrate, with some margin. The extra translation above and below the substrate increases the process time, but makes the process relatively insensitive to flatness of the substrate. If an autofocus device is used, the margins can be reduced or minimized.

If a single ultrashort pulsed laser beam is utilized the process may be relatively slow but uses only low pulse energy, for example about 2 μJ or less for glass and about 40 or less for sapphire. Parallel processing as described herein provides increased feasibility for high speed, in-line industrial application. In some applications commercially available laser products, for example fiber-based chirped pulse amplification (FCPA) laser technology available from IMRA America Inc., provide for ultrashort laser machining with practical, well established laser technology. For example, pulse energy of at least about 10 μJ, 20 μJ, 50 μJ, or 100 μJ support parallel processing. For example, 100 μJ output may be sufficient for processing sapphire with up to a 25-element array, with a corresponding increase in throughput for repetitive arrays of holes. As discussed above, additional methods and systems for providing high pulse energy in fiber-based systems have been disclosed.

FIG. 3A illustrates some components of an example of a closed-loop water circulation system 1060. The water temperature is regulated in a heated water bath 3010. Debris is removed by a water filter 3020. A water pump 3030 circulates the water through the system (water circulation is shown by dashed arrows). A degas filter 3040 removes gases in the water. A vacuum pump 3050 generates the pressure difference (e.g., shown by solid arrows) that removes the gas from the water. The workpiece fixture 1050 holds the workpiece 1005 (e.g., a target wafer or other target substrate) and allows the water to smoothly flow along the bottom surface of the workpiece. Although water can be used with the circulation system 1060, this is not a limitation and other liquids can be circulated.

FIG. 3B schematically illustrates a cross-sectional view of an example of the workpiece fixture 1050. The fixture 1050 can support the workpiece 1005, which may be a semiconductor wafer. A purpose of the workpiece fixture is to provide a smooth flow of water below the wafer and adjacent to the entrance surface(s) of the hole(s) to be drilled. The wafer is attached to the top plate of the fixture. In one implementation the depth of the water flow is less than about 4 mm, and may be maintained in the range from about 1 mm to less than about 5 mm In some implementations larger depth may be acceptable, for example 10 mm or 100 mm Minimizing or reducing the depth reduces the amount of water that is pumped through the system. The depth can also affect the jet of gas, debris and water that is ejected from the bottom of the hole.

The workpiece fixture 1050 can include an inlet 3072, an inlet reservoir 3074, an outlet 3076, and an outlet reservoir 3078. At the inlet 3072 of the workpiece fixture 1050 is a relatively large reservoir 3074 that has the purpose of transitioning the water flow from a round hose supplying the water to a wide, flat profile below the wafer. The exit reservoir 3078 also acts like an accumulator to prevent or reduce the likelihood of water pressure from backing up at the outlet 3076. A vent 3060 in the outlet tubing (shown in FIG. 3A) is open to the atmosphere to prevent the tube from filling with water and creating suction that can draw the water out faster than the pump is supplying water.

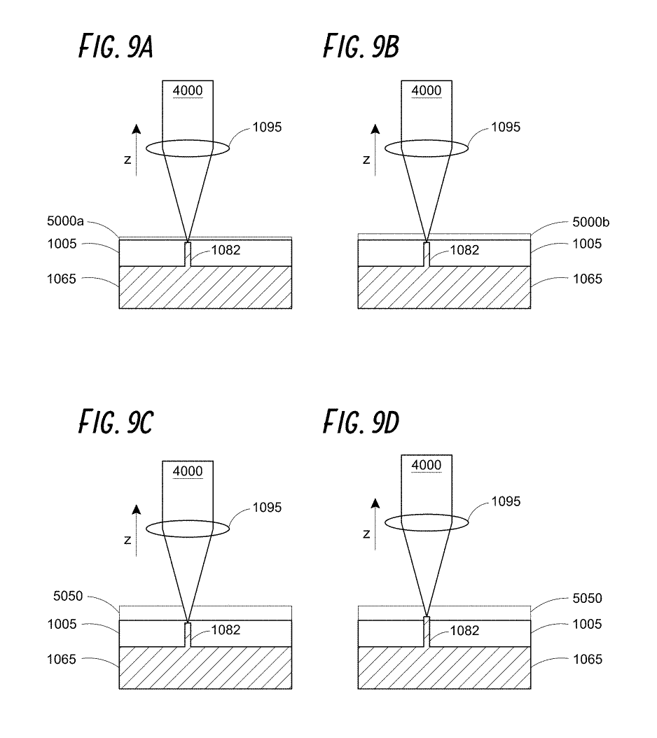

FIG. 3C schematically illustrates an example of a portion of a water-assisted drilling system in which a gas jet 1075 is arranged to direct unwanted liquid away from active/local laser processing locations, more particularly toward previously drilled holes 1080, a region on the where hole drilling is complete, or where no holes will be drilled. The gas jet also acts to prevent the liquid ejected from the hole from contacting the focusing lens. FIG. 3C shows the position of the entrance surface 4005 and the exit surface 4010 of a hole 1082 being drilled in the workpiece 1005. The drilling is initiated with the focal volume 4020 of the focused laser beam 4000 near the entrance surface 4005 (adjacent the liquid) of the workpiece 1005, with the focal volume 4020 of the laser beam 4000 being (relatively) moved toward the exit surface 4010 of the workpiece 1005 as the hole is drilled. The exit surface 4010 of the workpiece 1005 is typically exposed to the environment (e.g., air; however, see the examples in FIGS. 9A-9D where the exit surface of the workpiece is covered by a temporary transparent adhesive, coating, or cover). Thus, in the example system shown in FIG. 3C, the focal volume 4020 of the focused laser moves upwards as the hole is drilled. In other systems, the drilling can start at the workpiece surface adjacent to air and proceed toward the surface adjacent the liquid. Although the holes 1080, 1082 shown in FIG. 3C are perpendicular to the entrance and exit surfaces 4005, 4010 of the workpiece 1005, this is for purposes of illustration and is not a limitation. In other examples, the holes (or other types of features) can be formed at different angles relative to the workpiece surfaces, for example, by suitably orienting the workpiece 1005 and the laser beam 4000.

If the circulating water pressure is excessive, more water will be pushed out through holes machined in the workpiece. High water pressure may also deflect thin workpiece. If there is some negative pressure (such as being generated by suction from the outlet line), air will be drawn into the water through an existing hole and create an air bubble that can obstruct nearby hole drilling.

During certain experiments with the drilling process, plasma was visible in the water when the beam was below the bottom of the workpiece 1005 (e.g., below the entrance surface 4005 to the hole). As the machining starts, a jet of bubbles and debris became visible in the water. When the hole broke through the exit surface 4010 (at the top of the workpiece), a plume of water was ejected upwards from the exit surface 4010. An air or inert gas jet 1075 directed at the hole in the workpiece surface may be used to prevent the water in the plume produced when the hole cuts through from hitting the focusing lens (see e.g., FIG. 3C). A suction system could also prevent the water from falling to the surface where it can obscure the focusing for subsequent hole drilling. Alternatively, the plume can be directed toward a region where no holes will be made or where holes have already been made.

Additionally or alternatively, hole drilling may be carried out with a gas jet position such that the jet directs any water that leaks through a previously drilled hole away from local or active laser processing locations. FIG. 3C schematically illustrates an arrangement to force unwanted liquid away from active or nearby laser processing locations. By way of example liquid may be forced toward a region on the workpiece 1005 where holes 1080 have already been drilled or where no holes will be drilled. One or more gas jets 1075 from one or more gas jet sources operatively connected to the controller 1070 may be positioned to prevent a plume 1085 from reaching the focusing lens 1095 and to selectively eject liquid, including puddles 1090 formed on the workpiece surface, so as to avoid adverse effects on laser focusing and processing.

The water flow across the workpiece (near the entrance surface 4005 to a hole) should be high enough to displace any bubbles. Thus, a tradeoff exists between water flow rate, water pressure, bubble generation, water ejection and bubble removal. Experimental results suggest the bubbles stick too strongly to the glass surface to be removed by the water flow level that will not push water out of small diameter holes, for example 60-μm diameter holes. Increasing the flow rate raises the water pressure to excessive levels. Thus, a benefit of the circulating water may be to remove laser ablation debris from the water and to circulate degassed water to the wafer so that the bubbles are more quickly reabsorbed into the water.

Flowing water (which may be degassed)is preferred to reduce the bubbles generated by the laser ablation process (plasma and debris). If the bubbles block the entrance to a hole that is being formed, they will prevent water from entering and producing the cavitation pressure to remove the debris. Without subscribing to any particular theory water cavitation is believed to assist in ejection of ablation debris from deep holes. More particularly, the focused laser beam may interact with the water below or within the hole to produce optical breakdown and cavitation from which a pressure pulse of sufficient magnitude ejects the debris out of the hole or kerf. Without the water, the debris will not be able to exit a deep hole and recast will form on the sides of the wall, eventually completely blocking the hole. As a result, and as observed experimentally, the ablation process can terminate (when water is not used).

Machining results can be improved by modifying the hole drilling sequence according constraints induced by bubbles. In various arrangements, particularly when machining a large array of holes on a wafer, non-sequential machining may be utilized. Such machining will allow the bubbles generated during drilling to dissolve or dissipate into the water before an adjacent hole is machined. Preferably the hole sequence should be set by determining a distance larger than the distance the bubbles from a particular hole can travel (that have stuck to the bottom glass surface). By way of example, such a distance may be at least about 0.5 mm, and may be in a range from about 1-2 mm Further, the hole pattern should progress across the wafer in such a way that the bubbles dislocated by the flow of the water will be pushed to the region of the wafer where the holes have already been machined or where no holes will be made so that the bubbles do not interfere with the drilling. Similarly, water on the exit surface should be pushed in the same direction.

Some surprising effects were observed as a function of laser repetition rate. Although fiber laser systems are capable of relatively high repetition rates, it was experimentally determined that in many cases relatively low repetition rates drill through the largest range of substrate thicknesses and produce small hole diameters. However, such a dependency would not have been observed with low repetition rate ultrashort pulses, e.g.: 1 kHz. Conventional wisdom would suggest higher repetition rates are generally associated with increased processing speed. Also, it was determined experimentally that about a 10-fold increase in repetition rate (e.g.: 22 kHz to 200 kHz) was not effective to fabricate small holes.

Glass substrates of varying thickness were processed to form different hole diameters, D. It was discovered that the thicker the glass, the lower the repetition rate that is used to drill all the way through the substrate. Also, the larger the hole diameter the higher the maximum repetition rate that will penetrate the substrate. The aspect ratio of the hole (length/diameter) multiplied by the optimum repetition rate appears to be relatively constant around 250 to 350 kHz. For example, for a 20-μm diameter hole in 100-μm thick glass, the aspect ratio is 5, and the optimum repetition rate is 50 to 70 kHz. The following approximate relationship holds:

Rₒₚₜ≈(k·D)/L(t),

where k is in the range from about 250 to 350 kHz, L(t) is the hole depth as a function of time, t, (e.g.: length of hole), D is the hole diameter (a constant, for a non-tapered hole), and Rₒₚₜ is an optimum repetition rate, measured in kHz, for rapid drilling while substantially avoiding buildup of debris. Thus, in certain implementations, Rₒₚₜ is effectively an optimum repetition rate for drilling a hole of length L and diameter D. For non-circular holes, D represents a width of the hole. For other types of features (e.g., grooves or kerfs), D represents a lateral size of the feature, and L(t) represents a depth of the feature. For drilling a thru-hole (a hole that passes entirely through the workpiece), the final value of the length L corresponds to the thickness of the workpiece. For drilling a blind hole (a hole that does not pass entirely through the workpiece), the final value of the length L corresponds to the depth of the blind hole and is less than the full thickness of the workpiece. In other implementations, the proportionality factor k is in a range from about 100 to 1000 kHz. Near the beginning of hole drilling (e.g., t near 0), when the depth L(t) is small (e.g., much smaller than D), the repetition rate may be capped at a maximum repetition rate, and the above relationship applied after it provides a repetition rate below the maximum. The maximum repetition rate can be in a range from about 100 kHz to about 1 MHz.

Without subscribing to any particular theory the repetition rate phenomena may be related to resonant vibration of the water in the hole produced by water cavitation from the laser ablation. As the hole becomes deeper (or for holes formed in a thicker substrate), the mass of the water inside the hole increases. In order to increase machining speed varying the repetition rate with the depth of the hole to be drilled or decreasing the laser repetition rate as the hole becomes deeper may be beneficial. A selected repetition rate may be in the range from about 5-10 kHz up to about 50 kHz, 70 kHz, or 100 kHz.

In summary, the higher repetition rates can be used for thinner glass (e.g., smaller L). But for thicker glass (e.g., larger L), lower repetition rates can be used or the hole drilling ceases or becomes inefficient. Limits arise from water cavitation produced by the laser ablation near the water surface, which in turn produces a large pressure pulse. It is believed that the resonant frequency of an obstructing mass of water in the hole limits the maximum repetition rate. As the hole gets deeper, the obstructing mass grows and the resonant frequency gets lower. Thus, controllable repetition rate is beneficial for drilling substrates of varying thickness. Accordingly, certain embodiments of the drilling system may reduce the laser repetition rate as the hole is drilled (e.g., repetition rate may be inversely proportional to the hole depth).

### EXAMPLES

### Trepanning and Drilling—Observations

Holes were made by trepanning, wobble or a combination thereof. The resulting holes are very round in shape, with little dependence on the beam quality. The combination of beam motion and repetition rate affects the temporal and spatial separation of sequential pulses. Overlap can affect bubble interaction and heat accumulation, particularly for larger holes and less so for small holes. With commercially available galvanometer-based scanning (e.g.: pre-scanning and X-Y scanning) trepanning at speeds of 50-500 mm/s are achievable (up to a frequency of 1-3 kHz). Resonant trepanning has been utilized to increase trepanning frequency up to about 15 kHz in some cases. This higher speed reduces pulse overlap resulting in faster drilling speeds.

Overall, the hole machining speed tends to have an upper limit for certain practical commercial implementations. Increasing the pulse energy can permit a faster z-axis velocity and trepanning, but with more chipping at the exit surface. This chipping is likely due to the longer focal volume region that is above the ablation threshold. When the beam focus is still slightly below the exit surface, the higher pulse energy can cause stronger ablation and cavitation that then bursts through the thin remaining material resulting in more chipping.

There also may be a limit to the number of parallel beams that can be used, based on the size of the holes, the hole spacing and the laser pulse energy. To machine small holes, a focusing lens with a high numerical aperture (NA) is generally used. A high NA lens will have a relatively small focal plane field area. So the number of beams that can fit within the field will depend on the spacing between the beams. And since each beam much generate sufficient fluence to machine the target material, the total number of beams that can be generated will also depend on the maximum pulse energy the laser can produce, divided by the pulse energy used to machine one hole with the given focusing lens.

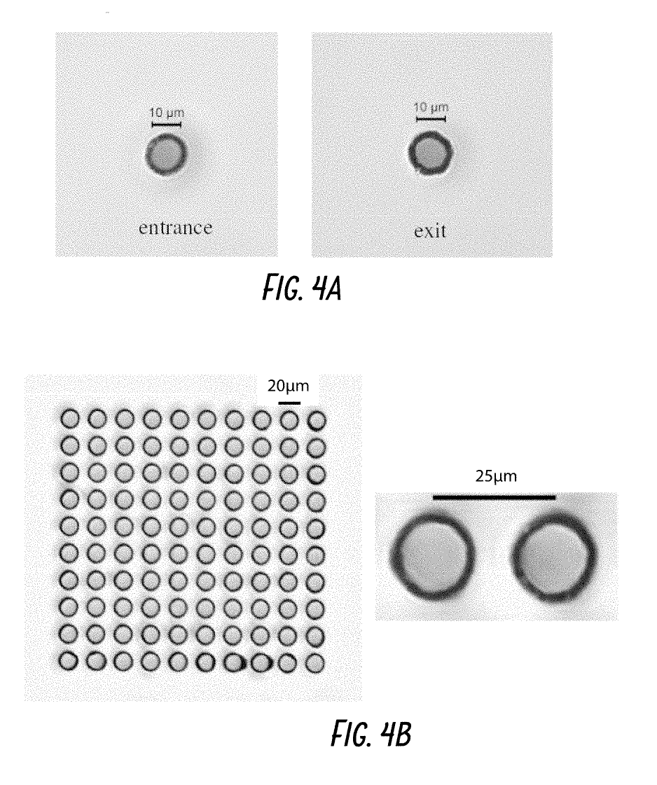

The minimum spacing of serially (sequentially) drilled holes depends at least partly on the hole diameter and sample thickness. If the holes are too closely spaced together, existing adjacent holes will distort the beam when focused at the entrance surface of the sample, reducing the likelihood of generating a small, precise focus spot. FIG. 4C schematically illustrates such limiting effects and shows an example of a minimum spacing 4050 between adjacent holes. The minimum spacing 4050 can be a multiple of the hole diameter D, e.g., 0.1 D, 0.25 D, 0.5 D, 0.75 D, 1.0 D, 1.5 D, 1.75 D, 2.0 D, 2.5 D, 3.0 D, or more, in various embodiments. Parallel drilling of an array of closely spaced holes does not suffer from this limitation of fine pitch, except possibly when making multiple arrays of holes that are close together.

With the relatively high NA of the focusing lens in some implementations, adjacent holes can interfere with focusing when the pitch is small, particularly at the start of the hole (bottom side of the workpiece). For parallel processing, the parallel holes evolve at the same rate, so this type of interference is less likely to cause a problem. However, there can be a limit to the number of holes that can be machined in parallel, in some cases, and this limit is expected to be much less than the number of closely spaced holes in an array. So this interference can be a challenge for large arrays of closely spaced holes in some cases. To meet this challenge in some implementations, it is possible to partially machine each hole or sub-array of holes to a depth where interference with adjacent holes can be reduced or avoided. Then, as a next step, the laser drilling system can repeatedly go over each hole or sub-array of holes, gradually increasing the depth, until all holes are completed.

The minimum pitch is not expected to depend on the substrate thickness, but the number of steps may depend on the substrate thickness. Smaller pitches may be limited to the mechanical strength of the small amount of glass between the holes. As described below, the use of a support material or layer for reducing exit hole chipping will also help to support the glass for very small hole pitch through thin glass.

Obtaining reduced hole pitches is possible, in some implementations, by such partially machining the entire array of holes to some certain depth before increasing the z-position of the focus to increase the depth. Such step-wise drilling of the entire array can be carried out with a highly-repeatable translation stage in order to return each time to substantially the same position for each hole, for example with precision of 1 μm or better.

By way of an example, using a serial-drilling approach, the minimum pitch for 20-μm diameter holes through 200-μm thick glass was found to be 100-150 μm. With use of the step-wise drilling approach hole pitch is expected be reduced, for example to 30 μm or smaller.

Additionally in the experiments the bubbles generated do not seem to interfere with the hole drilling. It is possible bubbles are ejected far enough away from the hole for the array size tested and a larger hole array might have yield problems, in some cases. For the purpose of testing, measuring the hole cross-section can verify that the positioning stages are in fact positioning the sample at the correct location for each round of hole drilling.

### Water-Assisted Drilling Results—Sequential Drilling

FIG. 4A shows an optical microscope image (with top-illumination) of the entrance surface (left) and exit surface (right) of a 10-μm diameter hole drilled through 100-μm thick glass. The exit diameter is approximately the same as the entrance diameter thereby indicating very low taper, for example on the order of about 1 μm or less over the 100-μm. The dark ring that defines the edge surface of the hole is due to accumulated light absorption or scattering along the thickness of the glass substrate (hole depth). Tapered holes made by conventional laser processes have an exit with a noticeably smaller diameter than the entrance.

FIG. 4B shows an optical microscope image (with top-illumination) of a 10×10 array of individually machined 20-μm diameter holes through 100-μm thick glass (left) and an expanded view of two adjacent holes (right). The 25-μm hole spacing (shown in the expanded view showing two machined holes) is near the minimum distance before adjacent hole interference becomes significant for this glass thickness and focusing lens NA.

The images in FIGS. 4A and 4B were taken with the sample supported so that there was nothing in focus below the holes. Notably, the edges of the holes show no chipping. As discussed above, the “dark” circle that defines the circumference of the hole is dark because the interior hole surface is relatively rough and scatters the illumination light.

### Trepanning and Drilling Results—Parallel Ultrashort Processing

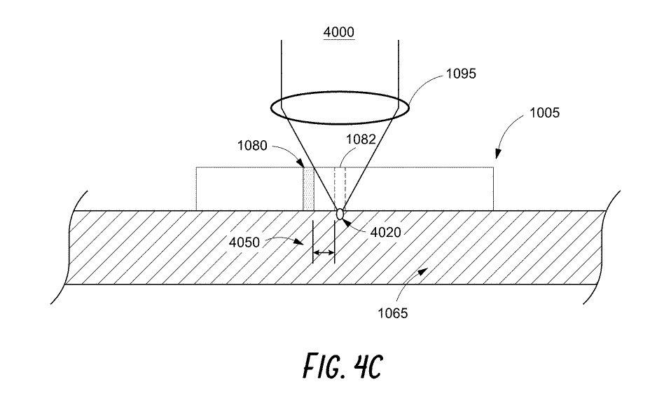

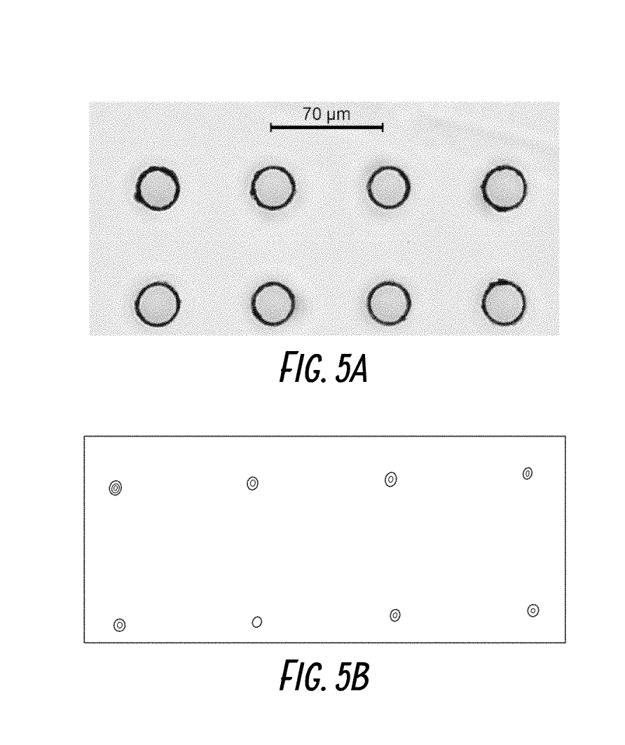

FIGS. 5A-5B illustrate examples of parallel processing results.

FIG. 5A is an optical microscope image (with top-illumination) showing a 2×4 array of 30-μm diameter holes with 70-μm spacing through 100-μm thick glass. The processing was carried out in parallel using an SLM. FIG. 5B is an image of the 2×4 array of beams produced by the SLM, captured by a beam profile camera in the transform plane (FT) of the SLM.

Hole quality is comparable to the holes produced with sequential (single beam) processing (see FIGS. 4A and 4B). The 8 holes in the 2×4 array were produced in roughly the same time as drilling a single hole with a single beam, but used more 8 times the pulse energy of that needed for the single hole (due to the −95% efficiency of the SLM).

### SLM Response Time and Frequency Response

The response time of a commercially available SLM supplied by Boulder Nonlinear Systems (BNS) was evaluated. The SLM software supplied by BNS was used to apply periodic phase patterns. Two phase patterns were used (1) blank pattern or (2) 1D blazed grating (period=8 pixels). A slit aperture in the Fourier plane was used to block the zero-order beam and transmit the 1st order of the blazed grating.

The SLM software periodically switched between the blank and blazed grating patterns resulting in a square wave pattern at the photodiode output. The rise and fall time was limited by the switching speed of the SLM. FIG. 6A is an oscilloscope image displaying switching frame rate. Note that the frame rate was 1/T where T=duration of one image. The oscilloscope sampling frequency was half the frame rate. Rise time (0-90%)=17 ms, fall time=6 ms for this SLM.

A summary of the frequency response for this example SLM is shown in the graph in FIG. 6B. For frame rates up to 30-40 Hz there is little or no reduction in the frequency response. Therefore, 20-30 ms for the SLM to change pattern before performing micromachining is considered to be commercially practical. During this waiting period the other system operations can be performed, e.g.: positioning the workpiece.

Other systems, setups, and parameters may be used in other implementations, which may provide the same or different results. Many variations are possible and are contemplated within the scope of this disclosure. Materials, components, features, structures, and/or elements may be added, removed, combined, or rearranged. Additionally, process or method steps may be added, removed, or reordered. No single feature or step, or group of features or steps, is indispensable or required for each embodiment.

### Repetition Rate and Hole Parameters

As discussed above an empirical relationship provides guidance for setting the laser pulse repetition rate based on certain hole parameters. Without subscribing to any particular theory an optimum repetition rate is approximated as: Rₒₚₜ≈(k·D)/L(t), where k is in the range from about 250 to 350 kHz, L(t) is the hole depth as a function of time, t, (e.g.: length of hole), D is the hole diameter (a constant, for non-tapered holes), and Rₒₚₜ is an optimum repetition rate, measured in kHz.

FIG. 7 is an example illustrating variation of repetition rate with hole depth according to the empirical relation. The relationship does not include consideration of z-axis speed which may be changed during drilling. By way of example, 40-μm diameter holes were drilled in 500-μm thick glass with a constant 25 kHz repetition rate. Alternatively, the repetition rate can be varied as a function of the hole depth using the empirical relationship above. For example, the repetition rate may decrease as the hole depth increases (e.g., approximately inversely in proportion to the hole depth).

The empirical relationship has undefined Rₒₚₜ at time t=0 (where L(t)=0). From a practical aspect a realizable upper limit for an initial drilling repetition rate, near the entrance surface of the workpiece, may be in the range from about 100 kHz up to about 1 MHz or 5 MHz. At high repetition rates, the expanding plasma or plume of a previous pulse can interfere with processing. In at least one implementation, water-assisted drilling is carried out with a bottom-up process which may limit plume interference, although plasma produced may limit processing. Regardless of the initial repetition rate, as hole drilling progresses the rate will be reduced rather quickly (e.g., as L(t) increases), thereby limiting speed improvement with very high initial repetition rates.

### Example Techniques for Reducing Exit Chipping of Thru-Holes

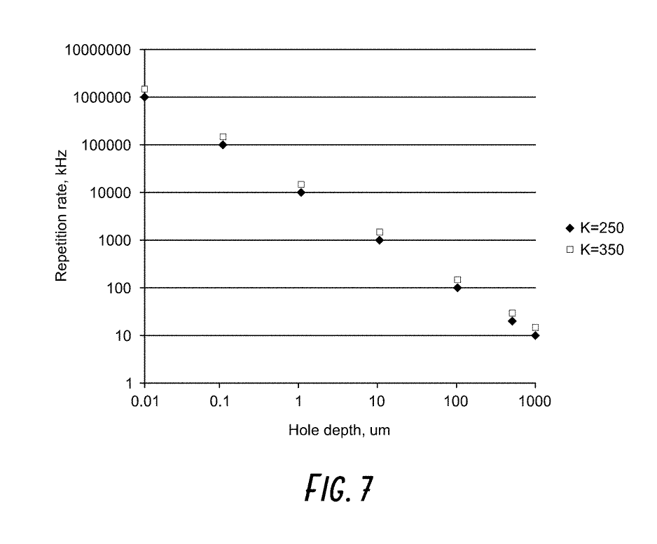

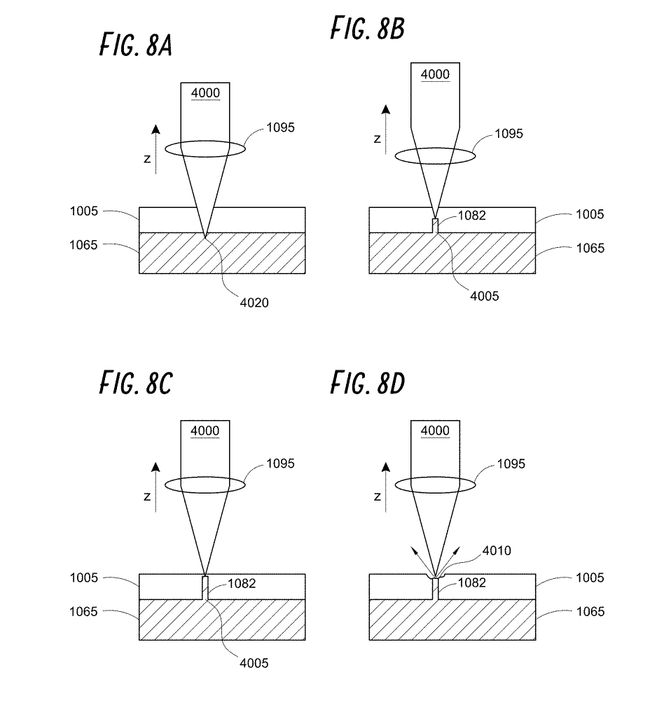

FIGS. 8A-9D schematically illustrate various examples of water-assisted laser drilling and example techniques for reducing exit chipping of thru-holes. Use of these techniques may improve thru-hole quality. In the following examples, the liquid used in the drilling system is water (e.g., degassed water) but any suitable liquid can be used.

Chipping may be reduced with the use of a removable coating, adhesive or support material (e.g., a support glass, carrier wafer, or other suitable transparent material) disposed on the exit surface of the workpiece (e.g., the surface not exposed to water).

In some experiments with water assisted drilling of thru-holes in glass, undesirable chips were produced around the edge of the hole near the exit surface of the target glass substrate. Chips along the edge of the exit hole can be about 5 μm in size, which can be a large fraction of a hole diameter. For example, in some drilling applications thru-holes having diameter in the range from about 5 μm to 50 μm may be required. In addition to degrading hole geometry, these chips may reduce the strength of the glass as stress concentrations, among other things. The exit surface may be at a glass-air or glass-water interface at which the beam exits.

Experiments have shown that chipping can be reduced by introducing, for example, a thin film coating layer, thick film coating layer, adhesive, or a thickness of support glass at a glass interface with or without a thin layer of adhesive. After the drilling operation is completed, the coating layer or support glass (with or without adhesive) can be removed (e.g., by washing in a solvent).

Without subscribing to any particular theory, it is believed that when the subsurface laser focus gets close to the exit surface, pressure from the laser ablation process and water cavitation (due to breakdown of the water) causes the remaining thin layer of glass to fracture before it can be ablated, causing the chips. The experimental fact that the chips increase in size with increased pulse energy tends to support this hypothesis.

The discussion which follows further illustrates certain aspects of substrate chipping and some example arrangements of the film(s), coating(s), adhesive(s), and/or support glass(es) to reduce or eliminate chipping.

FIGS. 8A-8D schematically illustrate an example of the water-assisted laser drilling of a thru-hole in a workpiece and formation of an exit chip. As shown in FIG. 8A, the laser beam 4000 is initially focused (e.g., by lens 1095) at a focal volume 4020 below the transparent workpiece 1005 (such as glass), in the water 1065, and moves upwards as a hole 1082 is drilled. This process is particularly suitable for processing substrates that are optically transparent at the laser wavelength. The laser focus moves (relatively) upward in the positive z-direction indicated in FIG. 8A. FIGS. 8B and 8C show the focal volume 4020 of the laser beam 4000 moving into the bulk of the glass workpiece 1005, where the laser beam begins material removal by laser ablation to form the hole 1082. The resulting debris is captured and cooled by the water in the hole 1082. The laser ablation also generates cavitation in the water. The pressure from the laser ablation and water cavitation helps to eject the debris from the hole 1082 through the hole entrance 4005 and into the water 1065 below the workpiece. Cooling the debris in the water prevents re-attachment of the debris to the inside surface of the hole. A plume of debris and gas bubbles ejected from the hole entrance may be visible in the water below the workpiece. After the debris-filled water is ejected from the hole, clean water is drawn into the hole as the cavitation pressure subsides. If the laser processing is stopped, for example, at the point shown in FIG. 8C, a blind hole that does not pass entirely through the workpiece 1005 would be formed. Various post-laser-processing techniques for transforming, if desired, a blind hole into a thru-hole that passes entirely through the workpiece are described below.

FIG. 8D illustrates how chipping may evolve near the exit surface 4010 of an otherwise cleanly drilled hole 1082. When the focus 4020 is near the surface of the workpiece 1005, the pressure from the ablation and water breakdown bursts through the thin remaining layer of glass, producing chipping and a rough edge at the exit 4010. This rough exit can be reduced by decreasing the laser pulse energy and slowing the z-direction speed as the focus nears the exit surface 4010.

When the pressure breaks through the glass, a small “jet” of water and debris is ejected from the exit hole 4010 (similar to the plume 1085 shown in FIG. 3C). The jet is represented by the lines with arrows in FIG. 8D. The ejected water can collect on the top surface of the workpiece (or may be removed by a gas jet or suction as described with reference to FIG. 3C).

FIGS. 9A-9D schematically illustrate example techniques for reducing exit chipping of thru-holes. FIG. 9A schematically illustrates an arrangement in which a thin, transparent layer 5000a is deposited on the workpiece to at least reduce, and preferably eliminate, exit chipping. This relatively thin transparent layer 5000a transmits the focused laser beam with low distortion and low absorption, and provides mechanical support to the thin remaining layer of glass when the laser focus nears the exit surface of the workpiece. The beam distortion advantageously should be sufficiently low to provide adequate focusing and cleanly drill the hole 1082. The absorption of the layer 5000a advantageously should be low enough to avoid excessive laser pulse energy loss and scattering as it is desired that the enclosed energy of the incident focused beam remain highly localized. In at least one implementation the thin layer may have thickness exceeding about 1000 nm and in the range from about 2 μm to 100 μm.

FIG. 9B schematically illustrates an arrangement in which a relatively thick, transparent layer 5000b is deposited (thick relative to the layer 5000a shown in FIG. 9A). Such a thickness may, for example, be tens of microns and up to about 100 μm, or somewhat greater. Such a thicker transparent layer may provide more mechanical support to the thin remaining layer of the workpiece (as the focal volume approaches the surface of the workpiece), but can cause more distortion to a tightly focused (e.g.: nearly diffraction limited) laser beam. In some implementations the laser processing system, for example laser drilling system 1000, may include optical/mechanical components to reduce or compensate aberrations associated with the film thickness in the presence of a strongly converging, high NA beam.

By way of example, a suitable thin (or thick) layer 5000a, 5000b will be thick enough to provide sufficient mechanical strength to withstand the laser-induced pressure but not so thick as to distort the focused laser beam as it passes through the coating in such a way as to affect drilled hole quality. The transparent layer 5000a, 5000b may comprise one or a plurality of dielectric layers. The layer 5000a, 5000b may be deposited on the workpiece using thin film techniques or may be coated on the workpiece. The layer 5000a, 5000b can comprise a transparent material such as a polymer. FIG. 9C schematically illustrates a support material 5050 bonded to top of the workpiece to at least reduce, and preferably eliminate, exit chipping. For example, the support material 5050 may comprise a thin piece of transparent material (such as sapphire, fused silica, or crown glass) that is bonded to the top surface of the workpiece using a thin layer of transparent adhesive. This thin sheet of transparent support material 5050 provides the mechanical support for the thin remaining layer of the workpiece material near the end of the drilling process to prevent the chipping and rough exit edge. For example, in at least one implementation the support material 5050 may have a thickness in a range from about 10 μm to 2 mm.

FIG. 9D illustrates a beneficial effect of the thin support material 5050. It can be seen that the hole 1082 does not go entirely through the support material 5050 after the thru-hole 1082 is completely formed in the workpiece. Thus, no water leaks to the top surface of the support material 5050 through the completed hole where it can distort the laser beam when machining subsequent holes and prevent successful machining The thin sheet of support material 5050 on top of the target workpiece can be thick enough so that the beam translation can be stopped before going all the way through the support material 5050. In at least one implementation the support material is in optical contact with the target workpiece. Considerations and remedies for beam distortion with increased film thickness discussed above also apply to the support material.

A suitable thin (or thick) layer or thin support material may also be beneficial for machining blind holes where the bottom of the blind hole is near the exit surface.

Example Techniques for Transforming a Blind Hole into a Thru-Hole

As used herein, a blind hole includes a hole that does not completely pass through the workpiece, whereas a thru-hole does completely pass through the workpiece. A blind hole includes a first, open end at the entrance surface 4005 to the workpiece. But, in contrast to a thru-hole (which has another open end at the exit surface 4010 of the workpiece), the blind hole has a second, closed end that is within the bulk of the workpiece. The second, closed end of a blind hole does not break through the surface 4010 of the workpiece (opposite of the entrance surface 4005), and there is material remaining between the second end of the blind hole and the surface 4010 of the workpiece. Blind holes may be formed by terminating the laser processing before the focal volume 4020 of the laser beam reaches the surface 4010 of the workpiece. For example, by terminating the laser processing at the point schematically illustrated in FIG. 8C, a blind hole 1082 would be formed. As will be further described below, various types of post-processing can be used to transform a blind hole into a thru-hole.

A possible advantage of forming thru-holes from post-processing of blind holes is that undesirable exit chipping (which may occur when the focal volume 4020 exits the surface 4010 of the workpiece 1005 as described with reference to FIG. 8D) can be reduced or avoided.

Therefore, if blind holes are formed in a transparent workpiece (e.g.: glass) with a closed end of the blind hole near the exit surface, and if a thru-hole is desired at one or more locations of the blind holes, the remaining material between the closed end of the blind hole and the exit surface of the workpiece (sometimes referred to herein as a membrane) may be selectively removed in a post-processing step, or otherwise after completion of blind-hole formation. In some implementations, the membrane material between the closed end of the blind hole and the exit surface may have a thickness in a range of about 0.1 μm to 1 μm, 1 μm to 5 μm, 5 μm to 10 μm, or another thickness, depending on the laser drilling process and the workpiece material.

By way of example, all or a portion of the workpiece surface may be laser processed or chemically etched (wet or dry) to remove a shallow depthwise portion of the workpiece including near the location of the blind hole and near the exit surface of the workpiece. The laser processing or chemical etching may remove the membrane to transform the blind hole into a thru-hole. Laser processing (e.g., with ultrashort laser pulses such as femtosecond pulses) may be used in conjunction with the chemical etching to increase the amount of material removed. In some implementations, at least a portion of the workpiece near the membrane of the blind hole can be laser processed, e.g., by laser polishing using a CO₂ laser (or other type of laser). In some implementations, some or all of the workpiece surface is processed to remove multiple membranes associated with multiple blind holes so that all (or a substantial portion) of the multiple blind holes are transformed to thru-holes. Some such implementations may improve processing speed, because the multiple blind holes are post-processed in parallel. For some types of chemical (e.g., acid) etching, both the upper and lower surfaces of the workpiece and the interior surface of the hole may be etched.

In at least one example, a thickness of the workpiece in the range from about 5 μm to 50 μm can be etched away (or otherwise processed) to open the blind hole. In doing so, pre-selected blind holes are effectively to be transformed into thru-holes, with negligible taper and generally having hole geometry in conformance with the geometry of the blind-holes. As a result of etching, some enlargement of the hole may occur and may be related to the thickness of material removed.

In some implementations, additionally or alternatively to other membrane processing techniques, ultrasonic processing may be utilized to remove the thin membrane material at or near the exit surface to transform the blind hole into a thru-hole. For example, relatively thin (e.g., about 1-5 μm) glass remaining near the exit surface can be removed ultrasonically to open a blind hole, thereby transforming the blind hole into a thru-hole. Additionally or alternatively, ultrasonic cleaning can be used to remove debris on the surface of the workpiece or inside the holes formed in the workpiece. Preferably, with any post-processing, any remaining chips (if present) near the hole edges would be much smaller than about 5-10 pm and can be removed (e.g., via ultrasonic cleaning). In other implementations, other microfabrication techniques can be used to remove the material to transform a blind hole into a thru-hole (e.g., micro-cutting, abrasive polishing, chemical mechanical polishing/planarization, plasma etching, etc.) Other possibilities exist for post-processing, including combinations of the above methods.

### Example Process and Production Considerations

Considerations arise in order to facilitate use of embodiments of the water-assisted drilling system 1000 in production environments, without introducing excessive process steps.

Some techniques for joining the workpiece and the support material (e.g.: carrier wafer) prior to water-assisted laser processing, and separating the same subsequent to processing, are discussed below. Additionally or alternatively, in some embodiments a layer 5000a, 5000b (e.g., a removable adhesive or coating) may be applied without use of a support material 5050, as illustrated above.

Also, because certain target substrates may be very thin, for example tens of microns to about 100 microns, transporting to a water-assisted laser material processing site warrants examination. Because of fragility, thin glass wafers may be transported with a carrier wafer. In some implementations known methods developed for use in semiconductor fabrication and other industries may advantageously be utilized.

In one implementation the workpiece 1005 and the support material 5050, as illustrated in FIG. 9C, were arranged in optical contact. Best contact was achieved after thoroughly cleaning the surfaces prior to placing them in contact. Some solvent between the pieces can remain. As the solvent evaporates, the two pieces will achieve optical contact as long as there are few or no particles on the surfaces or in the solvent.

Subsequent to laser based drilling, the workpiece was immersed in an ultrasonic water bath for 1 hour to clean and separate the pieces in optical contact. For example, the ultrasonic cleaning was able to remove debris on the surface of the workpiece or in the holes formed in the workpiece.

Additionally or alternatively, a thin piece of glass temporarily bonded to the workpiece can also support the target glass as the hole drilling process approaches the exit surface. In some implementations the support material can be the carrier glass wafer used to mechanically support the thin glass target material that may be very fragile to start with. Notably, large, thin substrates may be attached to a carrier wafer to provide mechanical support during handling and in the manufacturing process. If glass is used as the carrier wafer, it can also be helpful to prevent chipping. A possible disadvantage of using the glass carrier wafer as the support material 5050 for drilling is that the glass carrier wafer may not be reused since it may be partially machined or otherwise modified in the drilling process. The bonding layer should be sufficiently thin, for example, less than about 5 μm, to limit optical absorption and distortion of the laser beam passing through it. However, a thin coating can, in some cases, be more difficult to remove since it may be difficult for fresh solvent to circulate between the two pieces of glass in the separation.

Either optical contact or an adhesive layer between the target substrate and the support material can be used in some implementations. If there is a thin air gap between the two pieces, water may be drawn into this gap after the hole through the target substrate is completed. The water between the two pieces may distort the focus for subsequent, nearby holes. If only a single hole is to be machined or if the hole spacing is large, water between the two pieces may not be a concern. However, optical loss due to reflection at the glass-air interfaces can reduce the laser pulse energy available for machining below the support material.

Optical damage and debonding are to be considered when using thin adhesive layers. Debonding may be achieved by liquid solvents, ultraviolet (UV) light exposure, heat and/or mechanical peeling.

The thickness of the support layer or material depends on the strength of the layer or material. If the support is generally the same strength as glass, then the layer or material should be about the same thickness as the chip thickness currently observed, in order to reduce or prevent chipping of the target substrate. In many cases, the support layer or material will not be as strong as glass, so the selected layer or material would likely need to be thicker than observed chip thickness to prevent chipping.

Additionally or alternatively to a workpiece formed with optical contact, it was found that an arrangement with a coating layer, without support glass, could reduce chipping. It was found that the coating did not prevent drilling by absorbing or distorting the beam. Chipping still occurred, although somewhat less than without the coating. In some experiments, a thin coating was damaged before the hole drilled through, preventing a completed hole through the glass. This illustrates an advantage of selecting a support coating layer with a sufficiently high laser damage threshold.

In various experiments, several different transparent coating layers were applied to thin glass target substrates. Initially, it was assumed the damage threshold of the coating should be similar to glass in order to avoid damage to the coating early in the drilling process where the damage would then distort the sub-surface focusing of the laser. After processing, there was significant damage to the coating, in some cases much larger in area than the hole, suggesting the damage threshold of the coating is much lower than that of the target substrate glass. However, the damage to the coating seemed to occur late in the drilling process since through-holes were feasible, even for the holes that had significant coating damage.

In the experiments, two types of coating layers were used. One coating was water-soluble, and another coating required a proprietary solvent. A water-soluble coating may facilitate processing. One consideration is solvents may leave residues inside the holes that could affect the adhesion of filling material (if used).

As yet another example, dicing tape in a frame is sometimes used to support thin wafers. In some embodiments such tape may be utilized if the mechanical support to the remaining thin substrate glass near the end of the drilling process is sufficient to prevent chipping. Preferably, the tape would be optically transparent at the laser wavelength.

Numerous possibilities exist for adhesives or coatings for the layer 5000a, 5000b. For example, a temporary adhesive, Temploc (available from Denka Corporation, Campbell, Calif.), which is curable with UV light and removable by peeling in hot water (without organic solvents) can be used. In at least one preferred implementation coated glass substrates with uniform thickness of coating may be utilized.

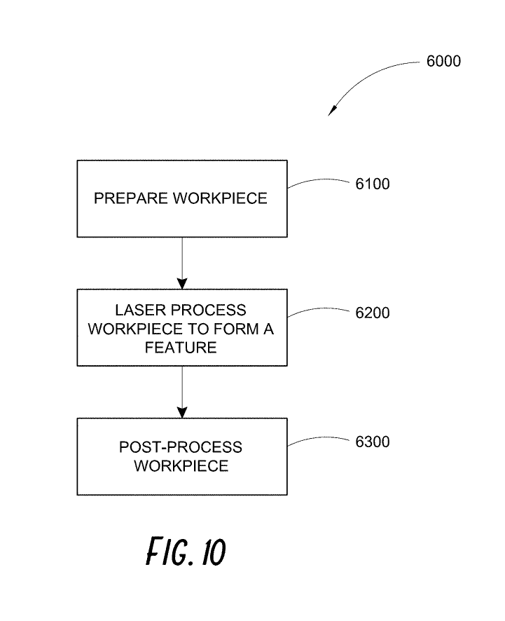

FIG. 10 is a flowchart that illustrates an example method 6000 for processing a workpiece. At block 6100, the workpiece can be prepared by one or more of adjoining an optically transparent support material to the workpiece, coating the workpiece so as to apply a thin film or thick film coating, or applying an adhesive to the workpiece. Examples of preparing the workpiece have been described with reference to FIGS. 9A-9D. The preparation of the workpiece can advantageously reduce exit chipping of thru-holes or other types of features formed in the workpiece. Block 6100 is optional and may not be performed in some implementations. For example, if a blind hole is to be drilled, the workpiece may, in some cases, not be coated or adjoined with a support material.

At block 6200, the workpiece is processed by a pulsed laser to form a feature at the surface or in the bulk of the workpiece. As described herein, the workpiece can comprise material that is transparent at the laser wavelength (e.g., glass, display glass, fused silica, quartz crown glass, tempered glass, non-tempered glass, soda lime glass, non-alkali glass, sapphire, silicon carbide (SiC), silicon, etc.). The workpiece can be processed by embodiments of the laser drilling system 1000 described herein. For example, a liquid (e.g., water, which can be degassed) can be flowed past a surface of the workpiece, e.g., as described with reference to FIGS. 1, 3A, 3C, 4C, and 8A-9D. The feature can be a thru-hole, blind hole, groove, kerf, trench, or other type of feature, an n×m array of any combination of such features, or other shape or pattern. The feature can have a substantially constant cross-section (depthwise) or can be tapered. In some implementations, the repetition rate of the pulsed laser is varied as the depth of the hole changes (e.g., with the repetition rate decreasing as the feature depth increases). During at least a portion of the processing, the laser repetition rate may be directly proportional to the diameter of the hole being drilled and inversely proportional to the depth of the hole being drilled.

At optional block 6300, the workpiece can be post-processed, to maintain compatibility with production equipment or to include one or more further processing steps. For example, the support material, coating, or adhesive can be removed (if applied at block 6100). The workpiece can be cleaned (e.g., ultrasonically), for example, to remove debris on the workpiece or in holes formed in the workpiece. As described herein, the post-processing at block 6300 can, in some embodiments, include processing methods (e.g., laser etching, laser polishing, chemical etching) to transform a blind hole into a thru-hole. In various implementations, none, some, or all of these types of post-processing operations can be applied at optional block 6300.

In some implementations of the method 6000, the workpiece can be prepared by a first entity (block 6100), received by a second entity that performs the laser processing (block 6200), and post-processed by a third entity (block 6300). The three entities can, but need not, be the same entity (or affiliates or subsidiaries of the same entity). For example, the second entity may receive the prepared workpiece from the first entity, perform the laser processing, and send the processed workpiece to the third entity for post-processing.

### Additional Examples and Aspects

In a first aspect, a liquid-assisted laser-based system for processing a workpiece is provided. The system comprises a laser source configured to generate a pulsed laser output; a multiple beam generator (MBG) configured to receive the pulsed laser output, said MBG configured such that a plurality of discrete beams are produced at an output thereof; a beam scanner and delivery system configured to deliver and focus said plurality of discrete beams to locations on or within said workpiece; a liquid circulation system configured to circulate a liquid, wherein a portion of said workpiece is in contact with said liquid when said liquid circulation system circulates said liquid; and a controller operatively connected to at least said laser source, said MBG, said liquid circulation system, and said beam scanner and delivery system.

In a second aspect, the liquid-assisted laser-based system of aspect 1, said system comprising a pre-scanner disposed between said laser source and said MBG, said pre-scanner arranged to steer said pulsed laser output along a pre-determined path.

In a third aspect, the liquid-assisted laser-based system of aspect 2, wherein said pre-scanner comprises a linear galvanometric scanner or a resonant scanner.

In a fourth aspect, the liquid-assisted laser-based system of any one of aspects 1-3, wherein said laser source comprises an ultrashort pulse laser (USP) and wherein said pulsed laser output comprises a laser pulse having a pulse width in the range from about 100 fs to 100 ps.

In a fifth aspect, the liquid-assisted laser-based system of any one of aspects 1-4, wherein said system is configured for drilling holes in a transparent material, wherein said laser output comprises pulses generated at a repetition rate based on a hole diameter, D, and hole depth, L, wherein said repetition rate is varied during drilling of an individual hole. The material is transparent at a laser processing wavelength.

In a sixth aspect, the liquid-assisted laser-based system of any one of aspects 1-5, wherein said system is configured for drilling holes in a transparent material, and wherein laser drilling of a hole in said transparent material is carried out at variable repetition rate including a first repetition rate, Rentrance, for drilling at or near an entrance surface and at a second repetition rate, Rexit, for drilling at or near an exit surface, wherein Rentrance>Rexit.

In a seventh aspect, the liquid-assisted laser-based system of any one of aspects 5 or 6, wherein said repetition rate is selected based at least partly on a relationship: Ropt=(k·D)/L(t), where k is in the range from about 250 kHz to 350 kHz, L(t) is the hole depth as a function of time, t, D is the hole diameter, and Ropt is an optimum repetition rate, measured in kHz.

In an eighth aspect, the liquid-assisted laser-based system of aspect 7, wherein a maximum repetition rate is in the range from about 100 kHz to about 1 MHz.

In a ninth aspect, the liquid-assisted laser-based system of any one of aspects 1-8, wherein said plurality of discrete beams forms an n×m array of parallel, focused beams impinging the workpiece surface, wherein n and m are in the range from 1 to 10.

In a tenth aspect, the liquid-assisted laser-based system of any one of aspects 1-9, wherein said MBG comprises one or a combination of a spatial light modulator (SLM), a diffractive optical element (DOE), or a bulk reflective optical element for beamsplitting and recombining.

In an eleventh aspect, the liquid-assisted laser-based system of any one of aspects 1-10, wherein said beam scanner and delivery system comprises an X-Y galvanometric scanner.

In a twelfth aspect, the liquid-assisted laser-based system of any one of aspects 1-11, wherein said workpiece is mounted on one or more translation stages, and said system comprises a z-axis translation mechanism for translating said workpiece or at least a portion of said beam scanner and delivery system along an optical axis.

In a thirteenth aspect, a liquid-assisted laser-based drilling system for processing a workpiece is disclosed. The workpiece comprises a material nearly transparent at a laser wavelength. The laser-based system comprises a laser source configured to generate a pulsed laser output and a liquid circulation system configured to circulate a liquid. The liquid circulation system comprises a degas filter; a filter configured to remove debris; and a liquid heater, wherein a portion of said workpiece is in contact with said liquid when said liquid circulation system circulates said liquid. The laser-based drilling system also comprises a controller operatively connected to said laser source and to said liquid circulation system.

In a fourteenth aspect, the liquid-assisted laser-based drilling system of aspect 13, further comprising a liquid source configured to supply said liquid to said liquid circulation system, and wherein said liquid is gas soluble.

In a fifteenth aspect, the liquid-assisted laser-based drilling system of aspect 13 or aspect 14, wherein said liquid circulation system comprises a gas jet operatively connected to said controller and arranged to selectively direct unwanted liquid away from active laser processing locations, toward previously drilled holes, a region on said transparent material where hole drilling is complete, or where no holes will be drilled.

In a sixteenth aspect, the liquid-assisted laser-based drilling system of any one of aspects 13-15, wherein an array of holes is to be drilled, and said controller is configured to carry out non-sequential drilling in accordance with constraints induced by bubbles that form during the laser processing, said non-sequential drilling comprising consecutively drilling holes at a spacing of at least about 0.5 mm.

In a seventeenth aspect, a method of liquid-assisted laser-based drilling an array of holes in a workpiece using a laser is disclosed. The method utilizes a non-sequential drilling method to allow bubbles generated during drilling to dissolve or dissipate into the liquid before an adjacent hole is machined. The non-sequential drilling method comprises: determining a distance larger than the distance the bubbles from a particular hole can travel; and controlling relative movement of the workpiece and the laser in such a way that the bubbles dislocated by the flow of the liquid will be displaced to a region of the workpiece where the holes have already been machined or where no holes will be made.

In an eighteenth aspect, the method of liquid-assisted laser-based drilling an array of holes of aspect 17, wherein said distance is at least about 0.5 mm.

In a nineteenth aspect, the method of liquid-assisted laser-based drilling an array of holes of aspect 17,wherein said distance is in a range from about 1-2 mm.

In a twentieth aspect, the method of liquid-assisted laser-based drilling an array of holes of any one of aspects 17-19, further comprising: selectively directing unwanted liquid away from a laser processing location, toward a previously drilled hole, a region on said transparent material where hole drilling is complete, or where no holes will be drilled.

In a twenty-first aspect, the method of liquid-assisted laser-based drilling an array of holes of aspect 20, wherein selectively directing unwanted liquid away from a laser processing location is carried out in part with a gas jet operatively connected to a controller.

In a twenty-second aspect, a method of liquid-assisted laser-based drilling an array of holes is disclosed. The method comprises: drilling a hole with laser pulses at a pre-selected repetition rate based on a hole diameter, D, and hole depth, L, wherein said repetition rate is varied during drilling of an individual hole in the array of holes.

In a twenty-third aspect, a liquid-assisted laser-based drilling system for processing a workpiece is disclosed. The system comprises: a fixture having an opening configured to support the workpiece. The fixture comprises: a liquid inlet; a liquid outlet; and a channel disposed adjacent the opening to permit at least a portion of a surface of the workpiece to be in contact with liquid when the fixture is attached to a liquid source, the channel configured to be in fluid communication with the liquid inlet and the liquid outlet. The liquid inlet comprises an inlet reservoir configured to be fluidly attached to the liquid source, and the inlet reservoir is configured to transition liquid flow from the liquid source to the channel. The liquid outlet comprises an outlet reservoir configured to reduce liquid pressure at the liquid outlet.

In a twenty-fourth aspect, a method for processing of a workpiece is disclosed. The method comprises: preparing said workpiece for laser-based material processing by one or more of adjoining an optically transparent support material to said workpiece, coating the workpiece so as to apply a thin or thick film coating, or applying an adhesive to said workpiece; and laser-processing said workpiece, subsequent to said preparing, wherein said workpiece comprises a transparent material at a laser processing wavelength, and said laser processing modifies a surface and bulk of the transparent material to form a feature having a pre-selected geometric shape, and wherein laser-processing induced geometric modifications at or near an interface of said workpiece in the presence of said support material, coating, or adhesive substantially conforms to the pre-selected shape.

In a twenty-fifth aspect, the method of processing according to aspect 24, further comprising: removing from said workpiece at least one of said optically transparent support material, said coating, or said adhesive.

In a twenty-sixth aspect, the method of processing according to aspect 24 or aspect 25, wherein said feature comprises a thru-hole in said workpiece, and said pre-selected geometric shape comprises a substantially constant circular hole diameter.

In a twenty-seventh aspect, the method of processing according to any one of the aspects 24-26, wherein said laser processing said workpiece comprises flowing a liquid past a surface of the workpiece during said laser processing. The liquid may comprise water (which may be degassed).

In a twenty-eighth aspect, the method of processing according to any one of aspects 24-27, wherein said feature comprises a blind hole, and said method further comprises processing at least a portion of the workpiece near the blind hole to transform the blind hole to a thru-hole.

In a twenty-ninth aspect, the method of processing according to aspect 28, wherein said processing at least a portion of the workpiece near the blind hole comprises one or more of: chemical etching, laser etching, laser polishing, ultrasonic processing, or utilizing a microfabrication technique.

In a thirtieth aspect, the method of processing according to any one of aspects 24-29, wherein said laser-processing is carried out with any one of the laser-based systems of aspects 1, 13, or 23.

In a thirty-first aspect, a method for processing a workpiece is disclosed. The method comprises laser processing said workpiece to form a blind hole having an open end at a first surface of said workpiece and a closed end near a second surface of said workpiece. The workpiece comprises a transparent material at a laser processing wavelength. Subsequent to said laser-processing, the method comprises removing material near the closed end of the blind hole to transform the blind hole into a thru-hole having an open end at the second surface of said workpiece.

In a thirty-second aspect, the method according to aspect 31, wherein said laser-processing comprises flowing a liquid past the first surface of the workpiece. The liquid may comprise water (which may be degassed).

In a thirty-third aspect, the method of aspect 31 or aspect 32, wherein removing said material near the closed end of the blind hole comprises one or more of: chemical etching, ultrasonic processing, or utilizing a microfabrication technique.

In a thirty-fourth aspect, the method of aspect 31 or aspect 32, wherein removing said material near the closed end of the blind hole comprises one or more of laser etching or laser polishing.

In a thirty-fifth aspect, the method according to any one of aspects 31 to 34, wherein said laser processing is performed with any one of the laser-based systems of claims 1, 13, or 23.

In a thirty-sixth aspect, a laser-based system for processing a workpiece is disclosed. The system comprises: a laser source configured to generate a pulsed laser output; a multiple beam generator (MBG) configured to receive the pulsed laser output, said MBG configured such that a plurality of discrete beams are produced at an output thereof; a beam scanner and delivery system configured to deliver and focus said plurality of discrete beams to locations on or within said workpiece; and a controller operatively connected to at least said laser source, said MBG, and said beam scanner and delivery system.

The following patents, published patent applications, and non-patent publications are pertinent to the present disclosure:

U.S. Pat. No. 3,991,296, “Apparatus for forming grooves using a laser.

U.S. Pat. No. 5,841, 099, “Method employing UV laser pulses of varied energy density to form depthwise self-limiting blind vias in multilayered targets”

U.S. Pat. No. 5,593,606, “Ultraviolet laser system and method for forming vias in multi-layered targets”.

U.S. Pat. No. 5,847,960, “Multi-tool positioning system”.

U.S. Pat. No. 5,948,291, “Laser beam distributor and computer program for controlling the same”.

U.S. Pat. No. 6,362,453, “Method of etching transparent solid material with laser beam”.

U.S. Pat. No. 6,990,285, “Method of making at least one hole in a transparent body and devices made by this method”.

U.S. Pat. Nos. 6,995,336 and 7,560,658, “Method for forming nanoscale features”.

U.S. Pat. No. 7,033,519, “Method of fabricating sub-micron structures in transparent dielectric materials”.

U.S. Pat. No. 7,486,705, “Femtosecond laser processing system with process parameters, controls, and feedback”.

U.S. Pat. No. 7,528,342, “Method and apparatus for via drilling and selective material removal using an ultrafast pulse laser”.

U.S. Pat. No. 7,626,138, “Transparent material processing with an ultrashort pulse laser”.

U.S. Pat. No. 8,158,493, “Laser-based material processing methods and systems”.

U.S. Pat. No. 8,199,398, “High power parallel fiber arrays”.

U.S. Patent Appl. Pub. No. 2005/0090813, “Method for removing waste products produced while stripping material in transparent objects by laser-induced plasma formation”.

U.S. Patent Appl. Pub. No. 2010/0025387, “Transparent material processing with an ultrashort laser”.

U.S. Patent Appl. Pub. No. 2003/0235385, “Method of fabricating sub-micron structures in transparent dielectric materials”.

U.S. Patent Appl. Pub. No. 2011/0111179, “Laser drilling technique for creating nanoscale holes”.

U.S. Patent Appl. Pub. No. 2012/0230353, “Optical pulse source with increased peak power”.

U.S. Patent Appl. Pub. No. 2013/0146570, “Methods and systems for use in laser machining”.

Ready, John F. (ed.), “Hole drilling”, LIA handbook of laser material processing, Chapter 13, pgs. 471-474, Laser Institute of America, 2001.

Marcinkevicius et al.; “Femtosecond Laser-assisted Three-dimensional Microfabrication in Silica”; Opt. Lett., vol. 26, no. 5; March 2001; pp. 277-279.

Y. Li et al., “Three-dimensional hole drilling of silica glass from the rear surface with femtosecond laser pulses,” Opt. Lett., vol. 26, no. 23, pp. 1912-1914, December 2001.

Y. Iga et al., “Characterization of Micro-Channels Fabricated by In-Water Ablation of Femtosecond Laser Pulses,” Jpn. J. Appl. Phys., vol. 43, no. 7A, pp. 4207-4211, July 2004.

D. J. Hwang et al., “Liquid-assisted femtosecond laser drilling of straight and three-dimensional microchannels in glass,” Appl. Phys. Mater. Sci. Process., vol. 79, pp. 605-612, 2004.

K. Ke et al., “Nanofabrication with ultrafast lasers at critical intensity,” SPIE Proceedings Vol. 5714, pp. 53-62, March 2005.

R. An et al., “Water-assisted femtosecond laser machining of electrospray nozzles on glass microfluidic devices,” Opt. Express, vol. 16, no. 19, pp. 15206-15211, September 2008.

R. An et al., “Simultaneous multi-microhole drilling of soda-lime glass by water-assisted ablation with femtosecond laser pulses,” Opt. Express, vol. 13, no. 6, pp. 1855-1859, March 2005.

Y. Li et al., “Femtosecond laser-induced breakdown in distilled water for fabricating the helical microchannels array,” Opt. Lett., vol. 36, no. 21, pp. 4236-4238, November 2011.

L. Jiang et al., “High-throughput rear-surface drilling of microchannels in glass based on electron dynamics control using femtosecond pulse trains,” Opt. Lett., vol. 37, no. 14, pp. 2781-2783, July 2012.

Engstrom et al., “Calibration of spatial light modulators suffering from spatially varying phase response”, Opt. Express, vol. 21, 16086-16103 (2013).

Y. Liu et al., “Optical fiber Fabry-Perot interferometer cavity fabricated by femtosecond laser-induced water breakdown for refractive index sensing”, Applied Optics, vol. 53, no. 3, 20 January 2014, 469-474.

Z. Kuang et al., “Ultrafast laser parallel microdrilling using multiple annular beams generated by a spatial light modulator”, Journal of Physics D: Appl. Phy. 47 (2014), 115501 (7 pp).

Certain processing steps or acts of the methods disclosed herein may be implemented in hardware, software, or firmware, which may be executed by one or more general and/or special purpose computers, processors, or controllers, including one or more floating point gate arrays (FPGAs), programmable logic devices (PLDs), application specific integrated circuits (ASICs), and/or any other suitable processing device. In certain embodiments, one or more functions provided by a controller or a control means may be implemented as software, instructions, logic, and/or modules executable by one or more hardware processing devices. In some embodiments, the software, instructions, logic, and/or modules may be stored on computer-readable media including non-transitory storage media implemented on a physical storage device and/or communication media that facilitates transfer of information. In various embodiments, some or all of the steps or acts of the disclosed methods or controller functionality may be performed automatically by one or more processing devices. Many variations are possible.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. As used herein, a phrase referring to “at least one of” a list of items refers to any combination of those items, including single members. As an example, “at least one of: a, b, or c” is intended to cover: a, b, c, a-b, a-c, b-c, and a-b-c. In addition, the articles “a,” “an”, and “the” as used in this application and the appended claims are to be construed to mean “one or more” or “at least one” unless specified otherwise.

The example experiments, experimental data, tables, graphs, plots, photographs, figures, and processing and/or operating parameters (e.g., values and/or ranges) described herein are intended to be illustrative of operating conditions of the disclosed systems and methods and are not intended to limit the scope of the operating conditions for various embodiments of the methods and systems disclosed herein. Additionally, the experiments, experimental data, calculated data, tables, graphs, plots, photographs, figures, and other data disclosed herein demonstrate various regimes in which embodiments of the disclosed systems and methods may operate effectively to produce one or more desired results. Such operating regimes and desired results are not limited solely to specific values of operating parameters, conditions, or results shown, for example, in a table, graph, plot, figure, or photograph, but also include suitable ranges including or spanning these specific values. Accordingly, the values disclosed herein include the range of values between any of the values listed or shown in the tables, graphs, plots, figures, photographs, etc. Additionally, the values disclosed herein include the range of values above or below any of the values listed or shown in the tables, graphs, plots, figures, photographs, etc. as might be demonstrated by other values listed or shown in the tables, graphs, plots, figures, photographs, etc. Also, although the data disclosed herein may establish one or more effective operating ranges and/or one or more desired results for certain embodiments, it is to be understood that not every embodiment need be operable in each such operating range or need produce each such desired result. Further, other embodiments of the disclosed systems and methods may operate in other operating regimes and/or produce other results than shown and described with reference to the example experiments, experimental data, tables, graphs, plots, photographs, figures, and other data herein. Also, for various values disclosed herein, relative terms “about”, “nearly”, “approximately”, “substantially”, and the like may be used. In general, unless indicated otherwise, relative terms mean within ±20%, within ±15%, within ±10%, within ±5%, depending on the embodiment.

Thus, while only certain embodiments have been specifically described herein, it will be apparent that numerous modifications may be made thereto without departing from the spirit and scope of the disclosure. Further, acronyms are used merely to enhance the readability of the specification and claims. It should be noted that these acronyms are not intended to lessen the generality of the terms used and they should not be construed to restrict the scope of the claims to the embodiments described therein.

1. A liquid-assisted laser-based system for processing a workpiece, the system comprising:
a laser source configured to generate a pulsed laser output;
a multiple beam generator (MBG) configured to receive the pulsed laser output, said MBG configured such that a plurality of discrete beams are produced at an output thereof;
a beam scanner and delivery system configured to deliver and focus said plurality of discrete beams to locations on or within said workpiece;
a liquid circulation system configured to circulate a liquid, wherein a portion of said workpiece is in contact with said liquid when said liquid circulation system circulates said liquid; and
a controller operatively connected to at least said laser source, said MBG, said liquid circulation system, and said beam scanner and delivery system.

2. The liquid-assisted laser-based system of claim 1, said system comprising a pre-scanner disposed between said laser source and said MBG, said pre-scanner arranged to steer said pulsed laser output along a pre-determined path.

3. The liquid-assisted laser-based system of claim 2, wherein said pre-scanner comprises a linear galvanometric scanner or a resonant scanner.

4. The liquid-assisted laser-based system of claim 1, wherein said laser source comprises an ultrashort pulse laser (USP) and wherein said pulsed laser output comprises a laser pulse having a pulse width in the range from about 100 fs to 100 ps.

5. The liquid-assisted laser-based system of claim 1, wherein said system is configured for drilling holes in a transparent material, said material being transparent at a laser processing wavelength, wherein said laser output comprises pulses generated at a repetition rate based on a hole diameter, D, and hole depth, L, wherein said repetition rate is varied during drilling of an individual hole.

6. The liquid-assisted laser-based system of claim 1, wherein said system is configured for drilling holes in a transparent material, and wherein laser drilling of a hole in said transparent material is carried out at a variable repetition rate including a first repetition rate, Rentrance, for drilling at or near an entrance surface and at a second repetition rate, Rexit, for drilling at or near an exit surface, wherein Rentrance>Rexit.

7. The liquid-assisted laser-based system of claim 6, wherein said repetition rate is selected based at least partly on a relationship: Ropt=(k·D)/L(t), where k is in the range from about 250 kHz to 350 kHz, L(t) is the hole depth as a function of time, t, D is the hole diameter, and Ropt is an optimum repetition rate, measured in kHz.

8. The liquid-assisted laser-based system of claim 7, wherein a maximum repetition rate is in the range from about 100 kHz to about 1 MHz.

9. The liquid-assisted laser-based system of claim 1, wherein said plurality of discrete beams forms an n×m array of parallel, focused beams impinging the workpiece surface, wherein n and m are in the range from 1 to 10.

10. The liquid-assisted laser-based system of claim 1, wherein said MBG comprises one or a combination of a spatial light modulator (SLM), a diffractive optical element (DOE), or a bulk reflective optical element for beamsplitting and recombining.

11. The liquid-assisted laser-based system of claim 1, wherein said beam scanner and delivery system comprises an X-Y galvanometric scanner.

12. The liquid-assisted laser-based system of claim 1, wherein said workpiece is mounted on one or more translation stages, and said system comprises a z-axis translation mechanism for translating said workpiece or at least a portion of said beam scanner and delivery system along an optical axis.

13. A liquid-assisted laser-based drilling system for processing a workpiece, said workpiece comprising a material nearly transparent at a laser wavelength, said laser-based system comprising:
a laser source configured to generate a pulsed laser output;
a liquid circulation system configured to circulate a liquid, the liquid circulation system comprising:
a degas filter;
a filter configured to remove debris; and
a liquid heater,
wherein a portion of said workpiece is in contact with said liquid when said liquid circulation system circulates said liquid, and
a controller operatively connected to said laser source and to said liquid circulation system.

14. The liquid-assisted laser-based drilling system of claim 13, further comprising a liquid source configured to supply said liquid to said liquid circulation system, and wherein said liquid is gas soluble.

15. The liquid-assisted laser-based drilling system of claim 13, wherein said liquid circulation system comprises a gas jet operatively connected to said controller and arranged to selectively direct unwanted liquid away from active laser processing locations, toward previously drilled holes, a region on said transparent material where hole drilling is complete, or where no holes will be drilled.

16. The liquid-assisted laser-based drilling system of claim 13, wherein an array of holes is to be drilled, and said controller is configured to carry out non-sequential drilling in accordance with constraints induced by bubbles that form during the laser processing, said non-sequential drilling comprising consecutively drilling holes at a spacing of at least about 0.5 mm.

17. A method of liquid-assisted laser-based drilling an array of holes, the method comprising:
drilling a hole with laser pulses at a repetition rate based on a hole diameter, D, and hole depth, L, wherein said repetition is varied during drilling of an individual hole in the array of holes.

18. The method of liquid-assisted laser-based drilling of claim 17, wherein said repetition rate is selected based at least partly on a relationship: repetition rate=(k·D)/L, where k is in the range from about 250 kHz to 350 kHz.

19. A method for processing a workpiece, the method comprising:
laser processing said workpiece to form a blind hole having an open end at a first surface of said workpiece and a closed end near a second surface of said workpiece, wherein said workpiece comprises a transparent material at a laser processing wavelength; and
subsequent to said laser-processing, removing material near the closed end of the blind hole to transform the blind hole into a thru-hole having an open end at the second surface of said workpiece.

20. The method according to claim 19, wherein said laser-processing comprises flowing a liquid past the first surface of the workpiece.

21. The method of claim 19, wherein removing said material near the closed end of the blind hole comprises one or more of: chemical etching, ultrasonic processing, or utilizing a microfabrication technique.

22. The method of claim 19, wherein removing said material near the closed end of the blind hole comprises one or more of laser etching or laser polishing.
